(19) United States
(12) Patent Application Publication
(10) Pub. No.: US 2013/0296383 A1
(43) Pub. Date: Nov. 7, 2013

(54) DECAHYDRO-1,4-METHANONAPHTHALEN CARBOXAMIDES

(71) Applicants: Jörg Greul, Leverkusen (DE); Jürgen Benting, Leichlingen (DE); Peter Dahmen, Neuss (DE); Ulrike Wachendorff-Neumann, Neuwied (DE)

(72) Inventors: Jörg Greul, Leverkusen (DE); Jürgen Benting, Leichlingen (DE); Peter Dahmen, Neuss (DE); Ulrike Wachendorff-Neumann, Neuwied (DE)

(73) Assignee: BAYER INTELLECTUAL PROPERTY GMBH, MONHEIM AM RHEIN (DE)

(21) Appl. No.: 13/880,552

(22) PCT Filed: Nov. 14, 2011
(86) PCT No.: PCT/EP11/70001

§ 371 Date: Jul. 15, 2013

(30) Foreign Application Priority Data
Nov. 15, 2010 (EP) 10191263.2

(51) Int. Cl. A01N 37/18; A01N 43/78; A01N 43/40; A01N 43/56

(52) U.S. Cl. CPC A01N 37/18; A01N 43/56; A01N 43/78; A01N 43/40
USPC 514/355; 548/374.1; 514/406; 548/200; 514/365; 564/183; 514/617; 546/316

(57) ABSTRACT

The present invention relates to decahydro-1,4-methanonaphthalen carboxamide derivatives of formula (Ia) or (Ib); their process of preparation, their use as fungicide, particularly in the form of fungicide compositions, and methods for the control of phytopathogenic fungi, notably of plants, using these compounds or compositions.

The present invention relates to novel bi- and tricyclic amide derivatives which have microbiocidal activity, in particular fungicidal activity. The invention also relates to the preparation of these compounds, to novel intermediates used in the preparation of these compounds, to agrochemical compositions which comprise at least one of the novel compounds as active ingredient, to the preparation of the compositions mentioned and to the use of the active ingredients or compositions in agriculture or horticulture for controlling or preventing infestation of plants by phytopathogenic microorganisms, preferably fungi.

WO-A 2004/035589 disclose certain tetrahydro-1,4-methanonaphthalen carboxamides:

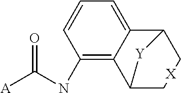

The present invention provides certain substituted decahydro-1,4-methanonaphthalen carboxamide compounds of formula (Ia) or (Ib) which are new:

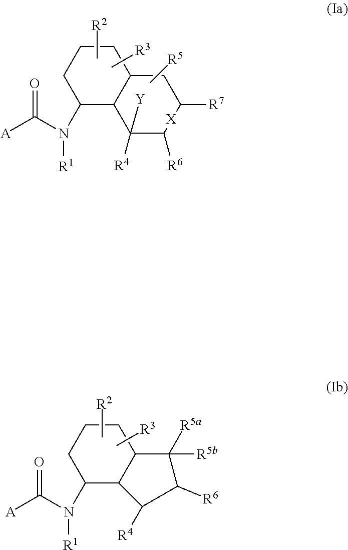

where
X is a single or double bond;
Y is O, S, N(R¹¹) or (CR¹²R¹³)(CR¹⁴R¹⁵)ₘ(CR¹⁶R¹⁷)ₙ;
m is 0 or 1;
n is 0 or 1;
R¹ is hydrogen, C₁₋₄ alkyl, C₁₋₄ haloalkyl, C₁₋₄ alkoxy, C₁₋₄ haloalkoxy, CH₂C≡CR⁸, CH₂CR^{9a}═CHR^{9b}, CH═C═CH₂ or COR¹⁰;
R² and R³ are each, independently, hydrogen, halogen, C₁₋₄ alkyl, C₁₋₄ alkoxy or C₁₋₄ haloalkoxy;
R⁴, R⁵, R⁶, R⁷, R^{5a} and R^{5b} are each, independently, hydrogen, halogen, C₁₋₄ alkyl, C₁₋₄ haloalkyl, C₁₋₄ alkoxy, C₁₋₄ haloalkoxy, C₁₋₄ alkylthio, C₁₋₄ haloalkylthio, hydroxymethyl, C₁₋₄ alkoxymethyl, C(O)CH₃ or C(O)OCH₃;
R⁸, R^{9a} and R^{9b} are each, independently, hydrogen, halogen, C₁₋₄ alkyl, C₁₋₄ haloalkyl or C₁₋₄ alkoxy(C₁₋₄)alkylene; and
R¹⁰ is hydrogen, C₁₋₆ alkyl, C₁₋₆ haloalkyl, C₁₋₄ alkoxy(C₁₋₄) alkylene, C₁₋₄ alkyl-S— (C₁₋₄) alkylene, C₁₋₄ alkoxy or aryl;
R¹¹ is hydrogen, C₁₋₄ alkyl, benzyl (in which the phenyl group is optionally substituted with up to three substituents, each independently selected from halogen, C₁₋₄ alkyl, C₁₋₄ haloalkyl and C₁₋₄ alkoxy), formyl, C(O)C₁₋₄ alkyl (optionally substituted by halogen or C₁₋₄ alkoxy), C(═O)O—C₁₋₆ alkyl (optionally substituted by halogen, C₁₋₄ alkoxy or cyano) or C₁₋₄ alkoxy(C₁₋₄)alkylene;
R¹², R¹³, R¹⁴, R¹⁵, R¹⁶ an R¹⁷ are each, independently, hydrogen, halogen, hydroxy, C₁₋₆ alkyl, C₂₋₆ alkenyl [both optionally substituted by halogen, hydroxy, C₁₋₄ alkoxy, ═O, aryl or O—C(O)—C₁₋₄ alkyl or a 3-7 membered carboxylic ring (itself optionally substituted by up to three methyl groups)], a 3-7 membered saturated ring (optionally substituted by up to three methyl groups and optionally containing one heteroatom selected from nitrogen and oxygen) or C₁₋₄ alkoxy;
or R¹² and R¹³ together with the carbon atom to which they are attached form the group C═O or a 3-5 membered carbocyclic ring (optionally substituted by up to three methyl groups and optionally with up to 2 heteroatoms each independently selected from O and N);
or R¹² and R¹³ together form a C₁₋₆ alkylidene (optionally substituted by up to three methyl groups) or a C₃₋₆ cycloalkylidene group (optionally substituted by up to three methyl groups);
A represents one of the radicals A1 to A18 below

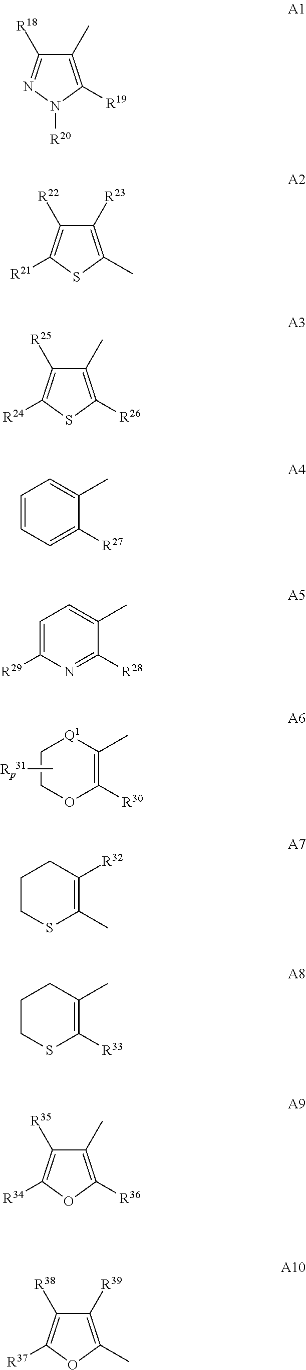

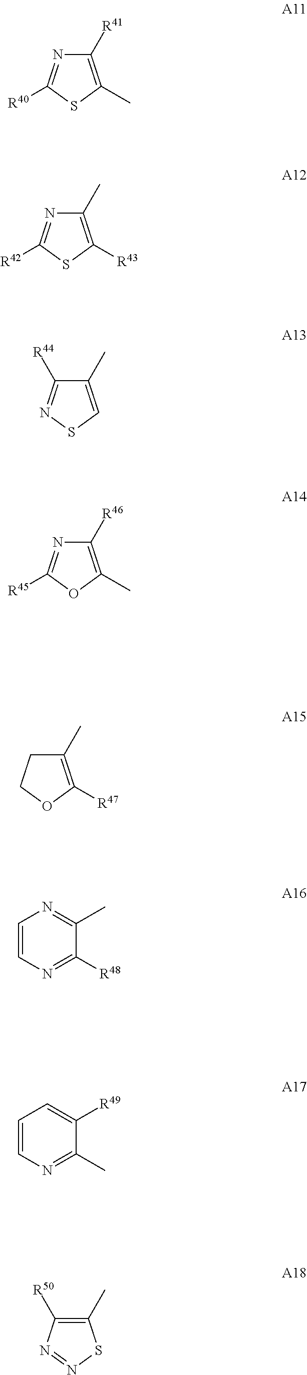

R¹⁸ represents hydrogen, cyano, halogen, nitro, C₁-C₄-alkyl, C₁-C₄-alkoxy, C₁-C₄-alkylthio, C₃-C₆-cycloalkyl, C₁-C₄-haloalkyl, C₁-C₄-haloalkoxy or C₁-C₄-haloalkylthio having in each case 1 to 5 halogen atoms, aminocarbonyl or aminocarbonyl-C₁-C₄-alkyl,
R¹⁹ represents hydrogen, halogen, cyano, C₁-C₄-alkyl, C₁-C₄-alkoxy or C₁-C₄-alkylthio,
R²⁰ represents hydrogen, C₁-C₄-alkyl, hydroxy-C₁-C₄-alkyl, C₂-C₆-alkenyl, C₃-C₆-cycloalkyl, C₁-C₄-alkylthio-C₁-C₄-alkyl, C₁-C₄-alkoxy-C₁-C₄-alkyl, C₁-C₄-haloalkyl, C₁-C₄-haloalkylthio-C₁-C₄-alkyl, C₁-C₄-haloalkoxy-C₁-C₄-alkyl having in each case 1 to 5 halogen atoms, or phenyl,
R²¹ and R²² independently of one another represent hydrogen, halogen, C₁-C₄-alkyl or C₁-C₄-haloalkyl having 1 to 5 halogen atoms,
R²³ represents halogen, cyano or C₁-C₄-alkyl, or C₁-C₄-haloalkyl or C₁-C₄-haloalkoxy having in each case 1 to 5 halogen atoms,
R²⁴ and R²⁵ independently of one another represent hydrogen, halogen, C₁-C₄-alkyl or C₁-C₄-haloalkyl having 1 to 5 halogen atoms,
R²⁶ represents hydrogen, halogen, C₁-C₄-alkyl or C₁-C₄-haloalkyl having 1 to 5 halogen atoms,
R²⁷ represents halogen, hydroxyl, cyano, C₁-C₆-alkyl, C₁-C₄-haloalkyl, C₁-C₄-haloalkoxy or C₁-C₄-haloalkylthio having in each case 1 to 5 halogen atoms,
R²⁸ represents halogen, hydroxyl, cyano, C₁-C₄-alkyl, C₁-C₄-alkoxy, C₁-C₄-alkylthio, C₁-C₄-haloalkyl, C₁-C₄-haloalkylthio or C₁-C₄-haloalkoxy having in each case 1 to 5 halogen atoms,
R²⁹ represents hydrogen, halogen, cyano, C₁-C₄-alkyl, C₁-C₄-alkoxy, C₁-C₄-alkylthio, C₁-C₄-haloalkyl, C₁-C₄-haloalkoxy having in each case 1 to 5 halogen atoms, C₁-C₄-alkylsulphinyl or C₁-C₄-alkylsulphonyl,
R³⁰ represents C₁-C₄-alkyl or C₁-C₄-haloalkyl having 1 to 5 halogen atoms,
R³¹ represents C₁-C₄-alkyl,
Q¹ represents S (sulphur), SO, SO₂ or CH₂,
p represents 0, 1 or 2, where R³¹ represents identical or different radicals if p represents 2,
R³² represents C₁-C₄-alkyl or C₁-C₄-haloalkyl having 1 to 5 halogen atoms,
R³³ represents C₁-C₄-alkyl or C₁-C₄-haloalkyl having 1 to 5 halogen atoms,
R³⁴ and R³⁵ independently of one another represent hydrogen, halogen, amino, C₁-C₄-alkyl or C₁-C₄-haloalkyl having 1 to 5 halogen atoms,
R³⁶ represents hydrogen, halogen, C₁-C₄-alkyl or C₁-C₄-haloalkyl having 1 to 5 halogen atoms,
R³⁷ and R³⁸ independently of one another represent hydrogen, halogen, amino, nitro, C₁-C₄-alkyl or C₁-C₄-haloalkyl having 1 to 5 halogen atoms,
R³⁹ represents hydrogen, halogen, C₁-C₄-alkyl or C₁-C₄-haloalkyl having 1 to 5 halogen atoms,
R⁴⁰ represents hydrogen, halogen, amino, C₁-C₄-alkylamino, di-(C₁-C₄-alkyl)amino, cyano, C₁-C₄-alkyl or C₁-C₄-haloalkyl having 1 to 5 halogen atoms,
R⁴¹ represents halogen, C₁-C₄-alkyl or C₁-C₄-haloalkyl having 1 to 5 halogen atoms,
R⁴² represents hydrogen, halogen, amino, C₁-C₄-alkylamino, di-(C₁-C₄-alkyl)amino, cyano, C₁-C₄-alkyl or C₁-C₄-haloalkyl having 1 to 5 halogen atoms,
R⁴³ represents halogen, C₁-C₄-alkyl or C₁-C₄-haloalkyl having 1 to 5 halogen atoms,
R⁴⁴ represents halogen, C₁-C₄-alkyl or C₁-C₄-haloalkyl having 1 to 5 halogen atoms,
R⁴⁵ represents hydrogen or C₁-C₄-alkyl,
R⁴⁶ represents halogen or C₁-C₄-alkyl,
R⁴⁷ represents C₁-C₄-alkyl or C₁-C₄-haloalkyl having 1 to 5 halogen atoms,
R⁴⁸ represents hydrogen, halogen, C₁-C₄-alkyl or C₁-C₄-haloalkyl having 1 to 5 halogen atoms,
R⁴⁹ represents halogen, hydroxyl, C₁-C₄-alkyl, C₁-C₄-alkoxy, C₁-C₄-alkylthio, C₁-C₄-haloalkyl, C₁-C₄-haloalkylthio or C₁-C₄-haloalkoxy having in each case 1 to 5 halogen atoms,
R⁵⁰ represents C₁-C₄-alkyl.

Halogen is fluoro, chloro, bromo or iodo; preferably fluoro, chloro or bromo.

Each alkyl moiety is a straight or branched chain and is, for example, methyl, ethyl, n-propyl, n-butyl, n-pentyl, n-hexyl, iso-propyl, sec-butyl, iso-butyl, tert-butyl, neo-pentyl, n-heptyl, 1,3-dimethylbutyl, 1,3-dimethylpentyl, 1-methyl-3-ethyl-butyl or 1,3,3-trimethylbutyl. Likewise, each alkylene moiety is a straight or branched chain.

Haloalkyl moieties are alkyl moieties which are substituted by one or more of the same or different halogen atoms and are, for example, CF₃, CF₂Cl, CHF₂, CH₂F, CCl₃, CF₃CH₂, CHF₂CH₂, CH₂FCH₂, CH₃CHF or CH₃CF₂.

Alkenyl and alkynyl moieties can be in the form of straight or branched chains.

Each alkenyl moiety, where appropriate, may be of either the (E)- or (Z)-configuration.

A 3-5 membered carbocyclic ring includes a spiro-three or five membered ring.

Aryl includes phenyl, naphthyl, anthracyl, fluorenyl and indanyl but is preferably phenyl.

Alkyliden moieties may be in the form of straight or branched chains. Alkyliden includes methylidene [CH₂═], ethylidene [CH₃C(H)═], n-propylidene, i-propylidene

[CH₃)₂CH═], n-butylidene, i-butylidene, 2-butylidene, n-pentylidene, i-pentylidene, neo-pentylidene, 2-pentylidene, n-hexylidene, 2-hexylidene, 3-hexylidene, i-hexylidene and neo-hexylidene.

Cycloalkyl includes cyclopropyl, cyclobutyl, cyclopentyl, cyclohexyl, cycloheptyl and cyclooctyl.

Cycloalkenyl includes cyclobutenyl, cyclopentenyl, cyclohexenyl and cycloheptenyl.

Cycloalkylidene includes cyclopropylidene [c(C₃H₄)═], cyclobutylidene, cyclopentylidene and cyclohexylidene.

In one aspect of the invention, R¹¹ is hydrogen, C₁₋₄ alkyl, benzyl (in which the phenyl group is optionally substituted with up to three substituents, each independently selected from halogen, C₁₋₄ alkyl, C₁₋₄ haloalkyl and C₁₋₄ alkoxy), formyl, C(O)C₁₋₄ alkyl or C₁₋₄ alkoxy (C₁₋₄) alkylene.

In another aspect of the invention, R¹², R¹³, R¹⁴, R¹⁵, R¹⁶ and R¹⁷ are each, independently, hydrogen C₁₋₄, alkyl or C₁₋₄ alkoxy.

Preferably X is a single bond.

In one aspect, Y is O, S, N(R¹¹), CH₂, CH₂CH₂, CH₂CH₂CH₂, C(CH₃)₂, CH(CH₃), CHCH(CH₃)₂, CH(C₂H₅), C(CH₃)(C₂H₅), CH(OCH₃) or C(OCH₃)₂; more preferably N(R¹¹), O, S, CH₂, CH₂CH₂, CH₂CH₂CH₂, C(CH₃)₂, CHCH(CH₃)₂, CH(CH₃) or CH(C₂H₅); even more preferably N(R¹¹), O, S, CH₂, CHCH(CH₃)₂ or CH₂CH₂; and still more preferably O, CH₂ or N(R¹¹).

Preferably Y is O, N(R¹¹) or (CR¹²R¹³)(CR¹⁴R¹⁵)ₘ(CR¹⁶R¹⁷)ₙ.

More preferably Y is O or (CR¹²R¹³)(CR¹⁴R¹⁵)ₘ(CR¹⁶R¹⁷)ₙ.

Even more preferably Y is (CR¹²R¹³)(CR¹⁴R¹⁵)ₘ(CR¹⁶R¹⁷⁾ₙ.

Still more preferably Y is (CR¹²R¹³).

Preferably n is 0.

Preferably m is 0.

Preferably R¹ is hydrogen, CH₂C≡CR⁸, CH═C═CH₂ or COR¹⁰.

More preferably R¹ is hydrogen, CH₂C═CH, CH═C═CH₂, C(O)H or C(O)CH₃.

Yet more preferably R¹ is hydrogen, CH₂C≡CH, CH═C═CH₂ or C(O)CH₃.

Even more preferably R¹ is hydrogen, CH₂C═CH or CH═C═CH₂.

Most preferably R¹ is hydrogen.

Preferably R² is hydrogen, halogen or C₁₋₄ alkyl.

More preferably R² is hydrogen or halogen.

Most preferably R² is hydrogen.

Preferably R³ is hydrogen or methyl.

More preferably R³ is hydrogen.

Preferably R⁴ is hydrogen, C₁₋₄ alkyl, halogen, C₁₋₄ haloalkyl, C₁₋₄ alkoxy, C(O)CH₃ or C(O)OCH₃.

More preferably R⁴ is hydrogen, C₁₋₂ alkyl, halogen, CF₃, methoxy, C(O)CH₃ or C(O)OCH₃.

Even more preferably R⁴ is hydrogen, methyl, chlorine, CF₃ or methoxy.

Most preferably R⁴ is hydrogen or methyl.

Preferably R⁵ is hydrogen, C₁₋₄ alkyl, halogen, C₁₋₄ haloalkyl, C₁₋₄ alkoxy, C(O)CH₃ or C(O)OCH₃.

More preferably R⁵ is hydrogen, C₁₋₂ alkyl, chlorine, CF₃, methoxy, C(O)CH₃ or C(O)OCH₃.

Most preferably R⁵ is hydrogen or methyl.

Preferably R⁶ is hydrogen, C₁₋₄ alkyl, C₁₋₄ alkoxy or C(O)CH₃.

More preferably R⁶ is hydrogen, methyl, methoxy or C(O)CH₃.

Most preferably R⁶ is hydrogen or methyl.

Preferably R⁷ is hydrogen, C₁₋₄ alkyl, C₁₋₄ alkoxy or C(O)CH₃.

More preferably R⁷ is hydrogen, methyl, methoxy or C(O)CH₃.

Most preferably R⁷ is hydrogen or methyl.

Preferably R⁸ is hydrogen, chloro, bromo, methyl or methoxy.

More preferably R⁸ is hydrogen, chloro or methyl.

Most preferably R⁸ is hydrogen.

Preferably R^{9a} is hydrogen, chloro, bromo, methyl or methoxy.

More preferably R^{9a} is hydrogen, chloro or methyl.

Most preferably R^{9a} is hydrogen.

Preferably R^{9b} is hydrogen, chloro, bromo, methyl or methoxy.

More preferably R^{9b} is hydrogen, chloro or methyl.

Most preferably R^{9b} is hydrogen.

Preferably R¹⁰ is hydrogen, methyl, OC(CH₃)₃ or CH₃OCH₂.

Preferably R¹¹ is hydrogen, C₁₋₄ alkyl, benzyl, formyl, C(O)CH₃ or C(O)OC(CH₃)₃;

More preferably R¹¹ is hydrogen or C₁₋₂ alkyl.

Preferably R¹¹ is C₁₋₄ alkyl, formyl, C(O)CH₃ or C(O)OC₁₋₆ alkyl (optionally substituted by halogen, CN or C₁₋₄ alkoxy).

More preferably R¹¹ is C(O)OC₁₋₄ alkyl.

In one aspect of the invention R¹², R¹³, R¹⁴, R¹⁵, R¹⁶ and R¹⁷ are each, independently, hydrogen, C₁₋₂ alkyl or methoxy.

Preferably R¹² and R¹³ are each, independently, hydrogen, halogen, C₁₋₅ alkyl, C₁₋₃ alkoxy, CH₂OH, CH(O), C₃₋₆ cycloalkyl, CH2O—C(═O)CH₃, CH₂—C₃₋₆ cycloalkyl or benzyl;

or R¹² and R¹³ together with the carbon atom to which they are attached form the group C═O or a 3-5 membered carbocyclic ring;

or R¹² and R¹³ together form C₁₋₅ alkylidene or C₃₋₆ cycloalkylidene.

More preferably R¹² and R¹³ are, independently, H, CH₃, C₂H₅, n-C₃H₇, i-C₃H₇, n-C₄H₉, sec-C₄H₉, i-C₄H₉, CH(C₂H₅)2, CH₂-cyclopropyl or cyclopentyl;

or R¹² and R¹³ together with the carbon atom to which they are attached form a 3-membered or 5-membered carbocyclic ring.

Preferably R1⁴ is H or CH₃.

Preferably R¹⁵ is H or CH₃.

Preferably R¹⁶ is H or CH₃.

Preferably R¹⁷ is H or CH₃.

A preferably represents one of the radicals A1, A2, A3, A4, A5, A6, A9, A10, A11, A12 or A17.

A particularly preferably represents one of the radicals

A1, A2, A4, A5, A6, A9, A11, A16, A17.

A very particularly preferably represents the radical A1 .

A furthermore very particularly preferably represents the radical A2.

A furthermore very particularly preferably represents the radical A4.

A furthermore very particularly preferably represents the radical A5.

A furthermore very particularly preferably represents the radical A6.

A furthermore very particularly preferably represents the radical A9.

A furthermore very particularly preferably represents the radical A11.

A furthermore very particularly preferably represents the radical A16.

A furthermore very particularly preferably represents the radical A17.
R¹⁸ preferably represents hydrogen, cyano, fluorine, chlorine, bromine, iodine, methyl, ethyl, isopropyl, methoxy, ethoxy, methylthio, ethylthio, cyclopropyl, C₁-C₂-haloalkyl, C₁-C₂-haloalkoxy having in each case 1 to 5 fluorine, chlorine and/or bromine atoms, trifluoromethylthio, difluoromethylthio, aminocarbonyl, aminocarbonylmethyl or aminocarbonylethyl.
R¹⁸ particularly preferably represents hydrogen, fluorine, chlorine, bromine, iodine, methyl, ethyl, isopropyl, monofluoromethyl, monofluoroethyl, difluoromethyl, trifluoromethyl, difluorochloromethyl, trichloromethyl, dichloromethyl, cyclopropyl, methoxy, ethoxy, trifluoromethoxy, trichloromethoxy, methylthio, ethylthio, trifluoromethylthio or difluoromethylthio.
R¹⁸ very particularly preferably represents hydrogen, fluorine, chlorine, bromine, iodine, methyl, isopropyl, monofluoromethyl, monofluoroethyl, difluoromethyl, trifluoromethyl, difluoro-chloromethyl, dichloromethyl or trichloromethyl.
R¹⁸ especially preferably represents methyl, difluoromethyl, dichloromethyl trifluoromethyl or 1-fluoroethyl.
R¹⁸ especially very preferably represents difluoromethyl or dichloromethyl.
R¹⁹ preferably represents hydrogen, fluorine, chlorine, bromine, iodine, methyl, ethyl, methoxy, ethoxy, methylthio or ethylthio.
R¹⁹ particularly preferably represents hydrogen, fluorine, chlorine, bromine, iodine or methyl.
R¹⁹ very particularly preferably represents hydrogen, fluorine, chlorine or methyl.
R¹⁹ especially preferably represents fluorine, chlorine.
R²⁰ preferably represents hydrogen, methyl, ethyl, n-propyl, isopropyl, C₁-C₂-haloalkyl having 1 to 5 fluorine, chlorine and/or bromine atoms, hydroxymethyl, hydroxyethyl, cyclopropyl, cyclopentyl, cyclohexyl or phenyl.
R²⁰ particularly preferably represents hydrogen, methyl, ethyl, isopropyl, trifluoromethyl, difluoromethyl, hydroxymethyl, hydroxyethyl or phenyl.
R²⁰ very particularly preferably represents hydrogen, methyl, trifluoromethyl or phenyl.
R²⁰ especially preferably represents methyl.

Particularly preferred are compounds according to formula (I) wherein R¹⁸ is difluoromethyl or dichloromethyl, R¹⁹ is fluorine or chlorine, and R²⁰ is methyl.

Particularly preferred are compounds according to formula (I) wherein R¹⁸ is difluoromethyl, R¹⁹ is fluorine, and R²⁰ is methyl.
R²¹ and R²² independently of one another preferably represent hydrogen, fluorine, chlorine, bromine, methyl, ethyl or C₁-C₂-haloalkyl having 1 to 5 fluorine, chlorine and/or bromine atoms.
R²¹ and R²² independently of one another particularly preferably represent hydrogen, fluorine, chlorine, bromine, methyl, ethyl, difluoromethyl, trifluoromethyl, difluorochloromethyl or trichloromethyl.
R²¹ and R²² independently of one another very particularly preferably represent hydrogen, fluorine, chlorine, bromine, methyl, ethyl, difluoromethyl, trifluoromethyl or trichloromethyl.
R²¹ and R²² especially preferably each represent hydrogen.
R²³ preferably represents fluorine, chlorine, bromine, cyano, methyl, ethyl, C₁-C₂-haloalkyl or C₁-C₂-haloalkoxy having in each case 1 to 5 fluorine, chlorine and/or bromine atoms.
R²³ particularly preferably represents fluorine, chlorine, bromine, cyano, methyl, trifluoromethyl, trifluoromethoxy, difluoromethoxy, difluorochloromethoxy or trichloromethoxy.
R²³ very particularly preferably represents fluorine, chlorine, bromine, iodine, methyl, trifluoromethyl or trifluoromethoxy.
R²³ especially preferably represents methyl or trifluoromethyl.
R²⁴ and R²⁵ independently of one another preferably represent hydrogen, fluorine, chlorine, bromine, methyl, ethyl or C₁-C₂-haloalkyl having 1 to 5 fluorine, chlorine and/or bromine atoms.
R²⁴ and R²⁵ independently of one another particularly preferably represent hydrogen, fluorine, chlorine, bromine, methyl, ethyl, difluoromethyl, trifluoromethyl, difluorochloromethyl or trichloromethyl.
R²⁴ and R²⁵ independently of one another very particularly preferably represent hydrogen, fluorine, chlorine, bromine, methyl, ethyl, difluoromethyl, trifluoromethyl or trichloromethyl.
R²⁴ and R²⁵ especially preferably each represent hydrogen.
R²⁶ preferably represents hydrogen, fluorine, chlorine, bromine, iodine, methyl, ethyl or C₁-C₂-haloalkyl having 1 to 5 fluorine, chlorine and/or bromine atoms.
R²⁶ particularly preferably represents hydrogen, fluorine, chlorine, bromine, iodine, methyl or trifluoromethyl.
R²⁶ very particularly preferably represents fluorine, chlorine, bromine, iodine, methyl or trifluoromethyl.
R²⁷ preferably represents fluorine, chlorine, bromine, iodine, hydroxyl, cyano, C₁-C₄-alkyl, C₁-C₂-haloalkyl, C₁-C₂-haloalkoxy or C₁-C₂-haloalkylthio having in each case 1 to 5 fluorine, chlorine and/or bromine atoms.
R²⁷ particularly preferably represents fluorine, chlorine, bromine, iodine, hydroxyl, cyano, methyl, ethyl, n-propyl, isopropyl, n-butyl, isobutyl, sec-butyl, tert-butyl, difluoromethyl, trifluoromethyl, difluorochloromethyl, trichloromethyl, trifluoromethoxy, difluoromethoxy, difluorochloromethoxy, trichloromethoxy, trifluoromethylthio, difluoromethylthio, difluoro-chloromethylthio or trichloromethylthio.
R²⁷ very particularly preferably represents fluorine, chlorine, bromine, iodine, methyl, difluoromethyl, trifluoromethyl or trichloromethyl.
R²⁷ especially preferably represents iodine, methyl, difluoromethyl or trifluoromethyl.
R²⁸ preferably represents fluorine, chlorine, bromine, iodine, hydroxyl, cyano, C₁-C₄-alkyl, methoxy, ethoxy, methylthio, ethylthio, difluoromethylthio, trifluoromethylthio, C₁-C₂-haloalkyl or C₁-C₂-haloalkoxy having in each case 1 to 5 fluorine, chlorine and/or bromine atoms.
R²⁸ particularly preferably represents fluorine, chlorine, bromine, iodine, hydroxyl, cyano, methyl, ethyl, n-propyl, isopropyl, n-butyl, isobutyl, sec-butyl, tert-butyl, trifluoromethyl, difluoromethyl, difluorochloromethyl, trichloromethyl, methoxy, ethoxy, methylthio, ethylthio, difluoromethylthio, trifluoromethylthio, trifluoromethoxy, difluoromethoxy, difluorochloromethoxy or trichloromethoxy.
R²⁸ very particularly preferably represents fluorine, chlorine, bromine, iodine, methyl, trifluoromethyl, difluoromethyl or trichloromethyl.
R²⁹ preferably represents hydrogen, fluorine, chlorine, bromine, iodine, cyano, C₁-C₄-alkyl, methoxy, ethoxy, methylthio, ethylthio, C₁-C₂-haloalkyl or C₁-C₂-haloalkoxy having in each case 1 to 5 fluorine, chlorine and/or bromine atoms, C₁-C₂-alkylsulphinyl or C₁-C₂-alkylsulphonyl.
R²⁹ particularly preferably represents hydrogen, fluorine, chlorine, bromine, iodine, cyano, n-propyl, isopropyl, n-butyl, isobutyl, sec-butyl, tert-butyl, trifluoromethyl, difluoromethyl, difluorochloromethyl, trichloromethyl, methoxy, ethoxy, methylthio, ethylthio, trifluoromethoxy, difluoromethoxy, difluorochloromethoxy, trichloromethoxy, methylsulphinyl or methylsulphonyl.
R²⁹ very particularly preferably represents hydrogen, fluorine, chlorine, bromine, iodine, n-propyl, isopropyl, n-butyl, isobutyl, sec-butyl, tert-butyl, trifluoromethyl, difluoromethyl, trichloromethyl, methylsulphinyl or methylsulphonyl.
R²⁹ especially preferably represents hydrogen.
R³⁰ preferably represents methyl, ethyl or C₁-C₂-haloalkyl having 1 to 5 fluorine, chlorine and/or bromine atoms.
R³⁰ particularly preferably represents methyl, ethyl, trifluoromethyl, difluoromethyl, difluorochloromethyl or trichloromethyl.
R³¹ preferably represents methyl or ethyl.
R³¹ particularly preferably represents methyl.
Q¹ preferably represents S (sulphur), SO₂ or CH₂.
Q¹ particularly preferably represents S (sulphur) or CH₂.
Q¹ very particularly preferably represents S (sulphur).
p preferably represents 0 or 1.
p particularly preferably represents 0.
R³² preferably represents methyl, ethyl or C₁-C₂-haloalkyl having 1 to 5 fluorine, chlorine and/or bromine atoms.
R³² particularly preferably represents methyl, ethyl, trifluoromethyl, difluoromethyl, difluoro-chloromethyl or trichloromethyl.
R³² very particularly preferably represents methyl, trifluoromethyl, difluoromethyl or trichloromethyl.
R³³ preferably represents methyl, ethyl or C₁-C₂-haloalkyl having 1 to 5 fluorine, chlorine and/or bromine atoms.
R³³ particularly preferably represents methyl, ethyl, trifluoromethyl, difluoromethyl, difluorochloromethyl or trichloromethyl.
R³³ very particularly preferably represents methyl, trifluoromethyl, difluoromethyl or trichloromethyl.
R³⁴ and R³⁵ independently of one another preferably represent hydrogen, fluorine, chlorine, bromine, amino, methyl, ethyl or C₁-C₂-haloalkyl having 1 to 5 fluorine, chlorine and/or bromine atoms.
R³⁴ and R³⁵ independently of one another particularly preferably represent hydrogen, fluorine, chlorine, bromine, methyl, ethyl, trifluoromethyl, difluoromethyl, difluorochloromethyl or trichloromethyl.
R³⁴ and R³⁵ independently of one another very particularly preferably represent hydrogen, fluorine, chlorine, bromine, methyl, trifluoromethyl, difluoromethyl or trichloromethyl.
R³⁴ and R³⁵ especially preferably each represent hydrogen.
R³⁶ preferably represents hydrogen, fluorine, chlorine, bromine, iodine, methyl, ethyl or C₁-C₂-haloalkyl having 1 to 5 fluorine, chlorine and/or bromine atoms.
R³⁶ particularly preferably represents hydrogen, fluorine, chlorine, bromine, iodine, methyl, ethyl, trifluoromethyl, difluoromethyl, difluorochloromethyl or trichloromethyl.
R³⁶ very particularly preferably represents hydrogen, fluorine, chlorine, bromine, iodine, methyl, trifluoromethyl, difluoromethyl or trichloromethyl.
R³⁶ especially preferably represents methyl.
R³⁷ and R³⁸ independently of one another preferably represent hydrogen, fluorine, chlorine, bromine, amino, nitro, methyl, ethyl or C₁-C₂-haloalkyl having 1 to 5 fluorine, chlorine and/or bromine atoms.
R³⁷ and R³⁸ independently of one another particularly preferably represent hydrogen, fluorine, chlorine, bromine, nitro, methyl, ethyl, trifluoromethyl, difluoromethyl, difluorochloromethyl or trichloromethyl.
R³⁷ and R³⁸ independently of one another very particularly preferably represent hydrogen, fluorine, chlorine, bromine, methyl, trifluoromethyl, difluoromethyl or trichloromethyl.
R³⁷ and R³⁸ especially preferably each represent hydrogen.
R³⁹ preferably represents hydrogen, fluorine, chlorine, bromine, methyl, ethyl or C₁-C₂-haloalkyl having 1 to 5 fluorine, chlorine and/or bromine atoms,
R³⁹ particularly preferably represents hydrogen, fluorine, chlorine, bromine, methyl, ethyl, trifluoromethyl, difluoromethyl, difluorochloromethyl or trichloromethyl.
R³⁹ very particularly preferably represents hydrogen, fluorine, chlorine, bromine, methyl, trifluoromethyl, difluoromethyl or trichloromethyl.
R³⁹ especially preferably represents methyl.
R⁴⁰ preferably represents hydrogen, fluorine, chlorine, bromine, amino, C₁-C₄-alkylamino, di(C₁-C₄-alkyl)amino, cyano, methyl, ethyl or C₁-C₂-haloalkyl having 1 to 5 fluorine, chlorine and/or bromine atoms.
R⁴⁰ particularly preferably represents hydrogen, fluorine, chlorine, bromine, amino, methylamino, dimethylamino, cyano, methyl, ethyl, trifluoromethyl, difluoromethyl, difluorochloromethyl or trichloromethyl.
R⁴⁰ very particularly preferably represents hydrogen, fluorine, chlorine, bromine, amino, methylamino, dimethylamino, methyl, trifluoromethyl, difluoromethyl or trichloromethyl.
R⁴⁰ especially preferably represents amino, methylamino, dimethylamino, methyl or trifluoromethyl.
R⁴¹ preferably represents fluorine, chlorine, bromine, methyl, ethyl or C₁-C₂-haloalkyl having 1 to 5 fluorine, chlorine and/or bromine atoms.
R⁴¹ particularly preferably represents fluorine, chlorine, bromine, methyl, ethyl, trifluoromethyl, difluoromethyl, difluorochloromethyl or trichloromethyl.
R⁴¹ very particularly preferably represents fluorine, chlorine, bromine, methyl, trifluoromethyl, difluoromethyl or trichloromethyl.
R⁴¹ especially preferably represents methyl, trifluoromethyl or difluoromethyl.
R⁴² preferably represents hydrogen, fluorine, chlorine, bromine, amino, C₁-C₄-alkylamino, di(C₁-C₄-alkyl)amino, cyano, methyl, ethyl or C₁-C₂-haloalkyl having 1 to 5 fluorine, chlorine and/or bromine atoms.
R⁴² particularly preferably represents hydrogen, fluorine, chlorine, bromine, amino, methylamino, dimethylamino, cyano, methyl, ethyl, trifluoromethyl, difluoromethyl, difluorochloromethyl or trichloromethyl.
R⁴² very particularly preferably represents hydrogen, fluorine, chlorine, bromine, amino, methylamino, dimethylamino, methyl, trifluoromethyl, difluoromethyl or trichloromethyl.
R⁴² especially preferably represents amino, methylamino, dimethylamino, methyl or trifluoromethyl.
R⁴³ preferably represents fluorine, chlorine, bromine, methyl, ethyl or C₁-C₂-haloalkyl having 1 to 5 fluorine, chlorine and/or bromine atoms.
R⁴³ particularly preferably represents fluorine, chlorine, bromine, methyl, ethyl, trifluoromethyl, difluoromethyl, difluorochloromethyl or trichloromethyl.
R⁴³ very particularly preferably represents fluorine, chlorine, bromine, methyl, trifluoromethyl, difluoromethyl or trichloromethyl.
R⁴³ especially preferably represents methyl, trifluoromethyl or difluoromethyl.
R⁴⁴ preferably represents fluorine, chlorine, bromine, methyl, ethyl or C₁-C₂-haloalkyl having 1 to 5 fluorine, chlorine and/or bromine atoms.
R⁴⁴ particularly preferably represents fluorine, chlorine, bromine, methyl, ethyl, trifluoromethyl, difluoromethyl, difluorochloromethyl or trichloromethyl.
R⁴⁴ very particularly preferably represents fluorine, chlorine, bromine, methyl, trifluoromethyl, difluoromethyl or trichloromethyl.
R⁴⁵ preferably represents hydrogen, methyl or ethyl.
R⁴⁵ particularly preferably represents methyl.
R⁴⁶ preferably represents fluorine, chlorine, bromine, methyl or ethyl.
R⁴⁶ particularly preferably represents fluorine, chlorine or methyl.
R⁴⁷ preferably represents methyl, ethyl or C₁-C₂-haloalkyl having 1 to 5 fluorine, chlorine and/or bromine atoms.
R⁴⁷ particularly preferably represents methyl, ethyl, trifluoromethyl, difluoromethyl, difluorochloromethyl or trichloromethyl.
R⁴⁷ very particularly preferably represents methyl, trifluoromethyl, difluoromethyl or trichloromethyl.
R⁴⁷ especially preferably represents methyl or trifluoromethyl.
R⁴⁸ preferably represents hydrogen, fluorine, chlorine, bromine, methyl, ethyl or C₁-C₂-haloalkyl having 1 to 5 fluorine, chlorine and/or bromine atoms.
R⁴⁸ particularly preferably represents hydrogen, fluorine, chlorine, bromine, methyl or trifluoromethyl.
R⁴⁹ preferably represents fluorine, chlorine, bromine, iodine, hydroxyl, C₁-C₄-alkyl, methoxy, ethoxy, methylthio, ethylthio, difluoromethylthio, trifluoromethylthio, C₁-C₂-haloalkyl or C₁-C₂-haloalkoxy having in each case 1 to 5 fluorine, chlorine and/or bromine atoms.
R⁴⁹ particularly preferably represents fluorine, chlorine, bromine, iodine, methyl, ethyl, n-propyl, isopropyl, n-butyl, isobutyl, sec-butyl, tert-butyl, trifluoromethyl, difluoromethyl, difluorochloromethyl or trichloromethyl.
R⁴⁹ very particularly preferably represents fluorine, chlorine, bromine, iodine, methyl, trifluoromethyl, difluoromethyl or trichloromethyl.
R⁵⁰ preferably represents methyl, ethyl, n-propyl or isopropyl.
R⁵⁰ particularly preferably represents methyl or ethyl.

The compounds of formula (IIa) or (IIb)

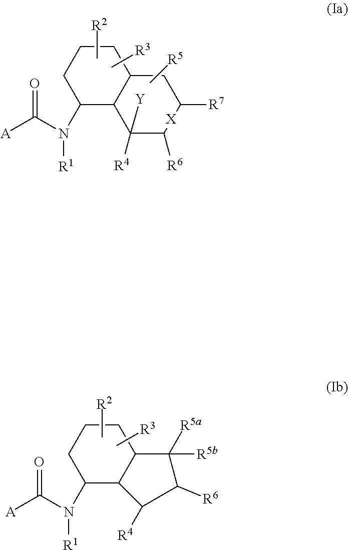

where X, Y, R², R³, R⁴, R⁵, R⁶, R⁷, R^{5a}, and R^{5b} are as defined above for a compound of formula (IIa) or (IIb) are useful as intermediates in the preparation of compounds of formula (Ia) or (Ib).

The compounds of formula (Ia), (Ib), (IIa) and (IIb) may exist as different geometric or optical isomers or in different tautomeric forms. This invention covers, for each formula, all such isomers and tautomers and mixtures thereof in all proportions as well as isotopic forms such as deuterated compounds.

The compounds according to formula (Ia) and (Ib) may be prepared according to the following reaction schemes.

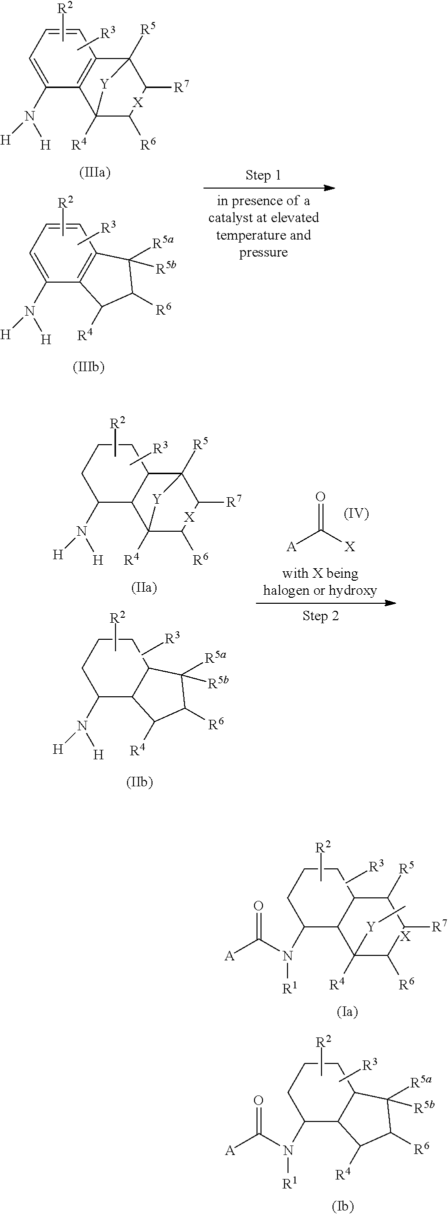

wherein R², R³, R⁴, R⁵, R⁶, R⁷, R^{5a} and R^{5b} are defined as above.

Most materials heterocyclic acids and acid halides [that is, compounds of formula (IV) are generally known from the literature (WO 04/035589A1) or may be synthesized according to known methods.

Starting Materials, compounds of formula (III) are generally known from the literature (WO-A 2004/035589, JP 62096472 for 1,1,3-Trimethyl-4-aminoindan) or may be synthesized according to known methods.

A compound of formula (IIa) or (IIb) is obtained from a compound of formula (IIIa) or (IIIb) by catalytical reduction, e.g Ru/C optionally in a solvent (such as methanol, ethanol or THF) at elevated temperature and pressure, to produce a crude isomere mixture of a compound of formula (IIa) or (IIb), which may be further purified by standard techniques.

A cis-/trans-mixture of a compound of formula (II) may be extracted and subsequent separation of the cis- and trans-isomers achieved by using flash chromatography.

Surprisingly, it has now been found that the novel compounds of formula (I) have, for practical purposes, a very advantageous spectrum of activities for protecting plants against diseases that are caused by fungi as well as by bacteria and viruses.

The compounds of formula (I) can be used in the agricultural sector and related fields of use as active ingredients for controlling plant pests. The novel compounds are distinguished by excellent activity at low rates of application, by being well tolerated by plants and by being environmentally safe. They have very useful curative, preventive and systemic properties and are used for protecting numerous cultivated plants. The compounds of formula I can be used to inhibit or destroy the pests that occur on plants or parts of plants (fruit, blossoms, leaves, stems, tubers, roots) of different crops of useful plants, while at the same time protecting also those parts of the plants that grow later e.g. from phytopathogenic microorganisms.

It is also possible to use compounds of formula (I) as dressing agents for the treatment of plant propagation material, in particular of seeds (fruit, tubers, grains) and plant cuttings (e.g. rice), for the protection against fungal infections as well as against phytopathogenic fungi occurring in the soil.

Furthermore the compounds according to present invention may be used for controlling fungi in related areas, for example in the protection of technical materials, including wood and wood related technical products, in food storage, in hygiene management, etc.

The compounds of formula (I) are, for example, effective against the phytopathogenic fungi of the following classes: Fungi imperfecti (e.g. Botrytis, Pyricularia, Helminthosporium, Fusarium, Septoria, Cercospora and Alternaria) and Basidiomycetes (e.g. Rhizoctonia, Hemileia, Puccinia). Additionally, they are also effective against the Ascomycetes classes (e.g. Venturia and Erysiphe, Podosphaera, Monilinia, Uncinula) and of the Oomycetes classes (e.g. Phytophthora, Pythium, Plasmopara). Outstanding activity has been observed against powdery mildew (Erysiphe spp.). Furthermore, the novel compounds of formula I are effective against phytopathogenic bacteria and viruses (e.g. against Xanthomonas spp, Pseudomonas spp, Erwinia amylovora as well as against the tobacco mosaic virus).

Within the scope of present invention, target crops to be protected typically comprise the following species of plants: cereal (wheat, barley, rye, oat, rice, maize, sorghum and related species); beet (sugar beet and fodder beet); pomes, drupes and soft fruit (apples, pears, plums, peaches, almonds, cherries, strawberries, raspberries and blackberries); leguminous plants (beans, lentils, peas, soybeans); oil plants (rape, mustard, poppy, olives, sunflowers, coconut, castor oil plants, cocoa beans, groundnuts); cucumber plants (pumpkins, cucumbers, melons); fibre plants (cotton, flax, hemp, jute); citrus fruit (oranges, lemons, grapefruit, mandarins); vegetables (spinach, lettuce, asparagus, cabbages, carrots, onions, tomatoes, potatoes, paprika); lauraceae (avocado, cinnamomum, camphor) or plants such as tobacco, nuts, coffee, eggplants, sugar cane, tea, pepper, vines, hops, bananas and natural rubber plants, as well as ornamentals.

The compounds of formula (I) are used in unmodified form or, preferably, together with the adjuvants conventionally employed in the art of formulation. To this end they are conveniently formulated in known manner to emulsifiable concentrates, coatable pastes, directly sprayable or dilutable solutions, dilute emulsions, wettable powders, soluble powders, dusts, granulates, and also encapsulations e.g. in polymeric substances. As with the type of the compositions, the methods of application, such as spraying, atomising, dusting, scattering, coating or pouring, are chosen in accordance with the intended objectives and the prevailing circumstances. The compositions may also contain further adjuvants such as stabilizers, antifoams, viscosity regulators, binders or tackifiers as well as fertilizers, micronutrient donors or other formulations for obtaining special effects.

Suitable carriers and adjuvants can be solid or liquid and are substances useful in formulation technology, e.g. natural or regenerated mineral substances, solvents, dispersants, wetting agents, tackifiers, thickeners, binders or fertilizers. Such carriers are for example described in WO97/33890.

The compounds of formula (I) are normally used in the form of compositions and can be applied to the crop area or plant to be treated, simultaneously or in succession with further compounds. These further compounds can be e.g. fertilizers or micronutrient donors or other preparations which influence the growth of plants. They can also be selective herbicides as well as insecticides, fungicides, bactericides, nematicides, molluscicides or mixtures of several of these preparations, if desired together with further carriers, surfactants or application promoting adjuvants customarily employed in the art of formulation.

The compounds of formula (I) can be mixed with other fungicides, resulting in some cases in unexpected synergistic activities. Mixing components which are particularly preferred are azoles, such as azaconazole, BAY 14120, bitertanol, bromuconazole, cyproconazole, difenoconazole, diniconazole, epoxiconazole, fenbuconazole, fluquinconazole, flusilazole, flutriafol, hexaconazole, imazalil, imibencon-azole, ipconazole, metconazole, myclobutanil, pefurazoate, penconazole, pyrifenox, prochloraz, propiconazole, simeconazole, tebuconazole, tetraconazole, triadimefon, triadimenol, triflumizole, triticonazole; pyrimidinyl carbinole, such as ancymidol, fenarimol, nuarimol; 2-amino-pyrimidines, such as bupirimate, dimethirimol, ethirimol; morpholines, such as dodemorph, fenpropidine, fenpropimorph, spiroxamine, tridemorph;

anilinopyrimidines, such as cyprodinil, mepanipyrim, pyrimethanil; pyrroles, such as fenpiclonil, fludioxonil; phenylamides, such as benalaxyl, furalaxyl, metalaxyl, R-metalaxyl, ofurace, oxadixyl; benzimidazoles, such as benomyl, carbendazim, debacarb, fuberidazole, thiabendazole; dicarboximides, such as chlozolinate, dichlozoline, iprodione, myclozoline, procymidone, vinclozoline; carboxamides, such as carboxin, fenfuram, flutolanil, mepronil, oxycarboxin, thifluzamide; guanidines, such as guazatine, dodine, iminoctadine; strobilurines, such as azoxystrobin, kresoxim-methyl, metomi-nostrobin, SSF-129, trifloxystrobin, picoxystrobin, BAS 500F (proposed name pyraclostrobin), BAS 520; dithiocarbamates, such as ferbam, mancozeb, maneb, metiram, propineb, thiram, zineb, ziram; N-halomethylthiotetrahydrophthalimides, such as captafol, captan, dichlofluanid, fluoromides, folpet, tolyfluanid; Cu-compounds, such as Bordeaux mixture, copper hydroxide, copper oxychloride, copper sulfate, cuprous oxide, mancopper, oxine-copper; nitrophenol-derivatives, such as dinocap, nitrothal-isopropyl; organo-p-derivatives, such as edifenphos, iprobenphos, isoprothiolane, phosdiphen, pyrazophos, tolclofos-methyl; various others, such as acibenzolar-S-methyl, anilazine, benthiavalicarb, blasticidin-S, chinomethionate, chloroneb, chlorothalonil, cyflufenamid, cymoxanil, dichlone, diclomezine, dicloran, diethofencarb, dimethomorph, SYP-LI90 (proposed name: flumorph), dithianon, ethaboxam, etridiazole, famoxadone, fenamidone, fenoxanil, fentin, ferimzone, fluazinam, flusulfamide, fenhexamid, fosetyl-aluminium, hymexazol, iprovalicarb, IKF-916 (cyazofamid), kasugamycin, methasulfocarb, metrafenone, nicobifen, pencycuron, phthalide, polyoxins, probenazole, propamocarb, pyroquilon, quinoxyfen, quintozene, sulfur, triazoxide, tricyclazole, triforine, validamycin, zoxamide (RH7281).

A preferred method of applying a compound of formula (I), or an agrochemical composition which contains at least one of said compounds, is foliar application. The frequency of application and the rate of application will depend on the risk of infestation by the corresponding pathogen. However, the compounds of formula I can also penetrate the plant through the roots via the soil (systemic action) by drenching the locus of the plant with a liquid formulation, or by applying the compounds in solid form to the soil, for example in granular form (soil application). In crops of water rice such granulates can be applied to the flooded rice field. The compounds of formula I may also be applied to seeds (coating) by impregnating the seeds or tubers either with a liquid formulation of the fungicide or coating them with a solid formulation.

A formulation [that is, a composition containing the compound of formula (I)] and, if desired, a solid or liquid adjuvant, is prepared in a known manner, typically by intimately mixing and/or grinding the compound with extenders, for example solvents, solid carriers and, optionally, surface active compounds (surfactants).

The agrochemical formulations will usually contain from 0.1 to 99% by weight, preferably from 0.1 to 95% by weight, of the compound of formula I, 99.9 to 1% by weight, preferably 99.8 to 5% by weight, of a solid or liquid adjuvant, and from 0 to 25% by weight, preferably from 0.1 to 25% by weight, of a surfactant.

Advantageous rates of application are normally from 5 g to 2 kg of active ingredient (a. i.) per hectare (ha), preferably from 10 g to 1 kg a. i./ha, most preferably from 20 g to 600 g a. i./ha. When used as seed drenching agent, convenient dosages are from 10 mg to 1 g of active substance per kg of seeds.

Whereas it is preferred to formulate commercial products as concentrates, the end user will normally use dilute formulations.

The following non-limiting Examples illustrate the above-described invention in more detail.

Most materials heterocyclic acids and acid halides are generally known from the literature (WO-A 2004/035589) or may be synthesized according to known methods.

The present invention also relates to a process for the preparation of compounds of formula (IVc) and (IVf). Thus according to a further aspect of the present invention there is provided a process P1 for the preparation of compounds of formula (IVc) and (IVf) as illustrated by the following reaction scheme:

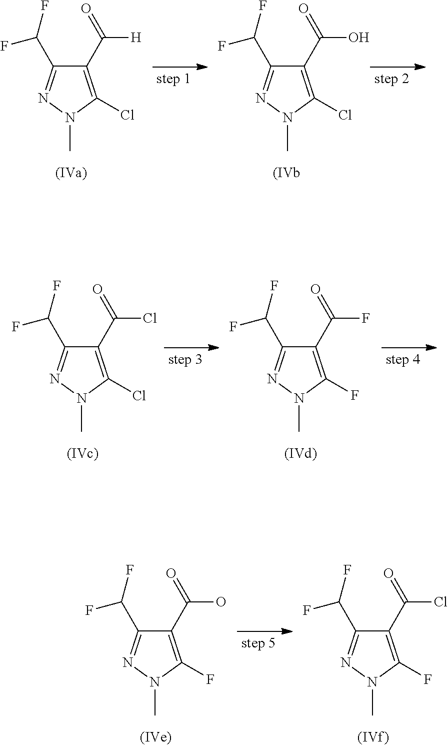

### Process P1

5-chloro-3-(difluoromethyl)-1-methyl-1H-pyrazole-4-carbaldehyde is known from WO-2004/014138 (reference example 35).

Step 1 of process P1 is performed in the presence of an oxidant, and if appropriate in the presence of a solvent.

Steps 2 and 5 of process P1 are performed in the presence of acid halide, and if appropriate in the presence of a solvent.

Step 3 of process P1 is performed in the presence of a fluorinating agent, and if appropriate in the presence of a solvent.

Step 4 of process P1 is performed in the presence of an acid or a base and if appropriate in the presence of a solvent

Suitable oxidants for carrying out step of process P1 according to the invention are in each case all inorganic and organic oxidant which are customary for such reactions. Preference is given to using benzyltriethylammonium permanganate; bromine; chlorine; m-chloroperbenzoic acid; chromic acid; chromium (VI) oxide; hydrogen peroxide; hydrogen peroxide-boron trifluoride; hydrogen peroxide-urea; 2-hydroxyperoxyhexafluoro-2-propanol; Iodine; oxygen-platinum catalyst, perbenzoic acid; peroxyacetyl nitrate; potassium permanganate; potassium ruthenate; pyridinium dichromate; ruthenium (VIII) oxide; silver (I) oxide; silver (II) oxide; silver nitrite; sodium chlorite; sodium hypochlorite; 2,2,6,6-tetramethylpiperidin-1-oxyl.

Suitable acid halides for carrying out steps 2 and 5 of process P1 according to the invention are in each case all organic or inorganic acid halides which are customary for such reactions. Preference is given to using notably phosgene, phosphorous trichloride, phosphorous pentachloride, phosphorous trichloride oxide; thionyl chloride; or carbon tetrachloride-triphenylphosphine.

Suitable fluorinating agent for carrying out step 3 of process P1 according to the invention is in each case all fluorinating agents which are customary for such reactions. Preference is given to using cesium fluoride; potassium fluoride; potassium fluoride-calcium difluoride; tetrabutylammonium fluoride.

Suitable solvents for carrying out steps 1 to 5 of process P1 and process P2 according to the invention are in each case all customary inert organic solvents. Preference is given to using optionally halogenated aliphatic, alicyclic or aromatic hydrocarbons, such as petroleum ether, hexane, heptane, cyclohexane, methylcyclohexane, benzene, toluene, xylene or decalin; chlorobenzene, dichlorobenzene, dichloromethane, chloroform, carbon tetrachloride, dichlorethane or trichlorethane; ethers, such as diethyl ether, cyclopentyl methylether, diisopropyl ether, methyl t-butyl ether, methyl t-amyl ether, dioxane, tetrahydrofuran, 2-methyl tetrahydrofuran, 1,2-dimethoxyethane, 1,2-diethoxyethane or anisole; nitriles, such as acetonitrile, propionitrile, n- or i-butyronitrile or benzonitrile; amides, such as N,N-dimethylformamide, N,N-dimethylacetamide, N-methylformanilide, N-methylpyrrolidone or hexamethylphosphoric triamide; esters, such as methyl acetate or ethyl acetate, sulphoxides, such as dimethyl sulphoxide, or sulphones, such as sulpholane.

When carrying out steps 1 to 5 of process P1 or process P2 according to the invention, the reaction temperatures can independently be varied within a relatively wide range. Generally, processes according to the invention are carried out at temperatures between 0° C. and 160° C., preferably between 10° C. and 120° C. A way to control the temperature for the processes according to the invention is to use the micro-waves technology.

Steps 1 to 5 of process P1 or process P2 according to the invention are generally independently carried out under atmospheric pressure. However, in each case, it is also possible to operate under elevated or reduced pressure.

When carrying out step 1 of process P1 according to the invention, generally 1 mol or other an excess of the oxidant is employed per mole of aldehyde of formula (Va). It is also possible to employ the reaction components in other ratios.

When carrying out carrying out steps 2 and 5 of process P1 to the invention, generally 1 mol or other an excess of the acid halides is employed per mole of acid of formula (IVb) or (IVe). It is also possible to employ the reaction components in other ratios.

When carrying out steps 3 of process P1 according to the invention generally 1 mol or other an excess of fluorinating agent is employed per mole of acid (IVc). It is also possible to employ the reaction components in other ratios.

When carrying out steps 4 of process P1 according to the invention generally 1 mol or other an excess of acid or base is employed per mole of acid halides (IVd). It is also possible to employ the reaction components in other ratios.

Work-up is carried out by customary methods. Generally, the reaction mixture is treated with water and the organic phase is separated off and, after drying, concentrated under reduced pressure. If appropriate, the remaining residue can, be freed by customary methods, such as chromatography, recrystallization or distillation, from any impurities that may still be present.

Compounds according to the invention can be prepared according to the above described process. It will nevertheless be understood that, on the basis of his general knowledge and of available publications, the skilled worker will be able to adapt these processes according to the specifics of each of the compounds according to the invention that is desired to be synthesized.

Throughout this description, temperatures are given in degrees Celsius; “NMR” means nuclear magnetic resonance spectrum; MS stands for mass spectrum; and“%” is percent by weight, unless corresponding concentrations are indicated in other units; “syn” refers to a syn configuration of the relevant substituent with respect to the annellated benzene ring; and“anti” refers to an anti configuration of the relevant substituent with respect to the annellated benzene ring.

The following abbreviations are used throughout this description: m. p.=melting point b. p.=boiling point. s=singlet br=broad d=doublet dd=doublet of doublets t=triplet q=quartet m=multiplet ppm=parts per million Table 30 shows selected melting point and selected NMR data, all with CDCI3 as the solvent (unless otherwise stated; if a mixture of solvents is present, this is indicated as, for example, [CDCh/d6-DMSO]), (no attempt is made to list all characterising data in all cases) for compounds disclosed in the description.

The following examples illustrate in a non limiting manner the preparation and efficacy of the compounds of formula (I) according to the invention.

### Synthesis of 5-chloro-3-(difluoromethyl)-1-methyl-1H-pyrazole-4-carboxylic acid (Example Vb-1)

In a 500 ml flask, 6.0 g (31 mmol) of 5-chloro-3-(difluoromethyl)-1-methyl-1H-pyrazole-4-carbaldehyde were added to 30 ml of toluene. A solution of 2.4 g (62 mmol) of sodium hydroxide in 6 ml of water was added to the reaction mixture, followed by 103 ml of a 30% solution of hydrogen peroxide in water, whilst keeping the temperature below 37° C. After the end of the addition, the reaction mixture was stirred at 50° C. for 7 hours. Once the reaction mixture was back to room temperature, the two phases were separated and the organic phase was extracted with 100 ml of water. The combined aqueous phases were acidified to pH 2 with aqueous hydrochloric acid. The resulting white precipitate was filtered, washed with 2*20 ml of water, and dried to yield 3.2 g of 5-chloro-3-(difluoromethyl)-1-methyl-1H-pyrazole-4-carboxylic acid as a white solid.

¹H NMR (400 MHz, DMSO-d₆) δ ppm: 3.78 (s, 3H); 7.12 (t, 1H, J_{HF}=53.60 Hz) 13.19 (s, 1H);

IR (KBr): 1688 cm⁻¹ (C═O); 2200-3200 cm⁻¹ broad (hydrogen bond);

### Synthesis of 5-chloro-3-(difluoromethyl)-1-methyl-1H-pyrazole-4-carbonyl chloride (Example Vc-1)

3.2 g of 5-chloro-3-(difluoromethyl)-1-methyl-1H-pyrazole-4-carboxylic acid and 44.3 ml of thionyl chloride were refluxed for 5 hours. After cooling down, the reaction mixture was evaporated under vacuum to yield 3.5 g of 5-chloro-3-(difluoromethyl)-1-methyl-1H-pyrazole-4-carbonyl chloride as a yellow oil.

¹H NMR (400 MHz, CHCl₃-d₆) δ ppm: 3.97 (s, 3H); 7.00 (t, J=52.01 Hz, 1H);

IR (TQ): 1759 and 1725 cm⁻¹ (C═O);

### Synthesis of 3-(difluoromethyl)-5-fluoro-1-methyl-1H-pyrazole-4-carbonyl fluoride (Example Vd-1)

To a dried solution of 4.0 g (70 mmol) of potassium fluoride in 21 ml of tetrahydrothiophene-1,1-dioxide was added a solution of 5.0 g (22 mmol) of 5-chloro-3-(difluoromethyl)-1-methyl-1H-pyrazole-4-carbonyl chloride in 15 ml of toluene at 100° C. The resulting reaction mixture was stirred at 190-200° C. for 22 hours. Distillation under vacuum yielded 8 g of a solution (25% molar) of 3-(difluoromethyl)-5-fluoro-1-methyl-1H-pyrazole-4-carbonyl fluoride in tetrahydro-thiophene-1,1-dioxide.

¹H NMR (250 MHz, CHCl₃-d₆) δ ppm: 3.87 (s, 3H); 6.79 (t, J=53.75 Hz, 1H);

¹⁹F NMR (250 MHz, CHCl₃-d₆) δ ppm: 45.37 (s, COF); −117.5 (d, J=28.2 Hz); −131.6 (m);

### Synthesis of 5-fluoro-3-(difluoromethyl)-1-methyl-1H-pyrazole-4-carboxylic acid (Example Ve-1)

To 400 ml of a 1N sodium hydroxyde aqueous solution, was added dropwise 67.5 g of a solution (10% molar) of 3-(difluoromethyl)-5-fluoro-1-methyl-1H-pyrazole-4-carbonyl fluoride in tetrahydrothiophene 1,1-dioxide. The temperature was kept below 20° C. during the addition. After 2 hours of stirring at room temperature, the reaction mixture was carefully acidified to pH 2 with concentrated aqueous hydrochloric acid. The resulting white precipitate was filtered, washed with water, and dried to yield 6 g of 5-fluoro-3-(difluoromethyl)-1-methyl-1H-pyrazole-4-carboxylic acid as a white solid.

¹H NMR (400 MHz, DMSO-d₆) δ ppm: 3.90 (s, 3H); 7.22 (t, 1H, J_{HF}=53.55 Hz); 13.33 (s, 1H);

### Synthesis of 5-fluoro-3-(difluoromethyl)-1-methyl-1H-pyrazole-4-carbonyl chloride (Example Vf-1)

9.1 g of 5-fluoro-3-(difluoromethyl)-1-methyl-1H-pyrazole-4-carboxylic acid and 75.5 ml of thionyl chloride were refluxed for 1.5 hours. After cooling down, the reaction mixture was evaporated under vacuum to yield 10 g of 5-fluoro-3-(difluoromethyl)-1-methyl-1H-pyrazole-4-carbonyl chloride as a yellow oil.

GC-MS; observed M/z: Molecular ion: (M⁺^{_{♦}})=212; fragments: (M⁺^{_{▪}}-Cl)=177 and (M⁺^{_{♦}}-F)=193;

### Synthesis of 9-Isopropyldecahydro-1,4-methanonaphthalen-5-amine

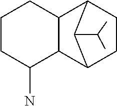

0.5 g of Ru/C (5%) are added to a solution comprising 2.013 g (10.0 mmol) 9-Isopropyl-1,2,3,4-tetrahydro-1,4-methanonaphthalen-5-amine in 30 ml of tetrahydrofuran, and the mixture is hydrogenated with 100 bar of hydrogen at 120° C. for 20 hours. After cooling to room temperature, the catalyst is filtered off through Celite 545 and the product is concentrated under reduced pressure. This gives 1.90 g (91%) of 9-Isopropyldecahydro-1,4-methanonaphthalen-5-amine having a purity of 91% according to MSD-HPLC.

¹H NMR (400 MHz, DMSO-d) δ ppm: 0.80-0.90 (m, 1H); 0.90-1.20 (m, 1H); 1.20-1.50 (m, 1H); 1.60-1.70 (m, 1H)

### Synthesis of 1,1,3-Trimethyloctahydro-1H-inden-4-amine

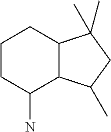

0.5 g of Ru/C (5%) are added to a solution comprising 2.103 g (12.0 mmol) 1,1,3-Trimethyl-4-aminoindan in 30 ml of tetrahydrofuran, and the mixture is hydrogenated with 100 bar of hydrogen at 120° C. for 20 hours. After cooling to room temperature, the catalyst is filtered off through Celite 545 and the product is concentrated under reduced pressure. This gives 2.0 g (75%) of 1,1,3-Trimethyloctahydro-1H-inden-4-amine having a purity of 75% according to MSD-HPLC.

¹H NMR (400 MHz, DMSO-d) δ ppm: 0.80-1.00 (m, 1H); 1.00-1.20 (m, 1H); 1.30-1.50 (m, 1H)

1,1,3-Trimethyl-4-aminoindan is known from literature JP 62096472

### EXAMPLE FOR THE AMIDE FORMATION

### Synthesis of 3-(difluoromethyl)-5-fluoro-N-(9-isopropyldecahydro-1,4-methanonaphthalen-5-yl)-1-methyl-1H-pyrazole-4-carboxamide

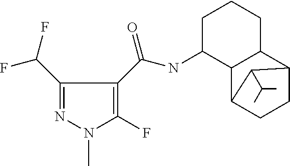 [SMILES: CCC(C)C1C2CCC1C1C(NC(=O)c3c(C(F)F)nn(C)c3F)CCCC21]

To a mixture of 0.566 g (2.73 mmol) 9-isopropyldecahydro-1,4-methanonaphthalen-5-amine and 0.565 g (4.09 mmol) potassiumcarbonate in 30 ml acetonitrile was added 0.638 g (3.00 mmol) 3-(difluoromethyl)-5-fluoro-1-methyl-1H-pyrazole-4-carbonyl chloride and stirred at ambient temperature for 20 h. At the end of the reaction the reactionmixture was extracted with ethylacetate and water. The organic layer was dried over natriumsulfate and the solvent was removed by vacuum. Finally 0.660 g (53%) of 3-(difluoromethyl)-5-fluoro-N-(9-isopropyldecahydro-1,4-methanonaphthalen-5-yl)-1-methyl-1H-pyrazole-4-carboxamide with a purity of 92% LC-MS was isolated. log P (acid) of 4.87.

¹H NMR (400 MHz, DMSO-d) δ ppm: 0.80-1.00 (m, 1H); 1.00-1.50 (m, 1H); 1.50-2.20 (m, 1H); 3.70-3.80 (s, 1H); 6.90-7.30 (m, 1H).

The following compounds of formula (Ic)

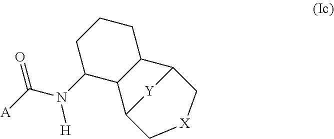

Have been exemplified with the substituent according to table 1

TABLE 1

| Ex. | A | Y | R⁸ | X |
|---|---|---|---|---|
| 1 | 3-(difluoromethyl)-5- | CHR⁸ | iPr | bond |
| | fluoro-1-methyl-1H- | | | |
| | pyrazol-4-yl | | | |
| 2 | 3-ethyl-5-fluoro-1- | CHR⁸ | iPr | bond |
| | methyl-1H-pyrazol-4-yl | | | |
| 3 | 5-fluoro-1,3-dimethyl- | CHR⁸ | iPr | bond |
| | 1H-pyrazol-4-yl | | | |
| 4 | 5-chloro-3- | CHR⁸ | iPr | bond |
| | (difluoromethyl)-1- | | | |
| | methyl-1H-pyrazol-4-yl | | | |
| 5 | 1-methyl-3- | CHR⁸ | iPr | bond |
| | (trifluoromethyl)-1H- | | | |
| | pyrazol-4-yl | | | |
| 6 | 2-methyl-4- | CHR⁸ | iPr | bond |
| | (trifluoromethyl)-1,3- | | | |
| | thiazol-5-yl | | | |
| 7 | 4-(difluoromethyl)-2- | CHR⁸ | iPr | bond |
| | methyl-1,3-thiazol-5-yl | | | |
| 8 | 2-(trifluoromethyl)phenyl | CHR⁸ | iPr | bond |
| 9 | 2-chloropyridin-3-yl | CHR⁸ | iPr | bond |

Abbreviation:
iPr = Propan-2-yl

### NMR-Data and Log P-Values of Selected Examples of Table 1

### NMR-Peaklist Method

¹H-NMR data of the selected examples of table 1 are written in form of ¹H-NMR-peak lists. To each signal peak are listed the δ-value in ppm and the signal intensity:

Example 1
DMSO-d₆
7.5674 (1.21) 7.5472 (1.22) 7.465 (0.42) 7.4438 (0.46) 7.417 (0.92) 7.3955 (0.88) 7.2035 (1.24) 7.1954
(1.9) 7.0685 (2.7) 7.0603 (4.1) 6.9337 (1.5) 6.9255 (2.1) 4.1346 (0.39) 4.1234 (0.41) 4.0569 (1.09)
4.0391 (1.65) 4.0215 (1.84) 4.0039 (1.24) 3.995 (0.83) 3.9572 (0.34) 3.8634 (0.42) 3.8521 (0.42)
3.7718 (12.86) 3.7616 (12.06) 3.7041 (0.35) 3.6765 (0.73) 3.4752 (0.74) 3.4604 (0.78) 3.4363 (0.44)
3.4265 (0.5) 3.3057 (96.4) 3.1808 (0.47) 2.9911 (1.69) 2.9664 (0.34) 2.9338 (0.45) 2.8907 (2.24)
2.7322 (1.44) 2.6737 (0.65) 2.6691 (0.85) 2.6646 (0.63) 2.5224 (3.96) 2.509 (50.83) 2.5046 (93.38)
2.5001 (120.93) 2.4958 (83.16) 2.4914 (40.05) 2.3862 (0.58) 2.3314 (0.66) 2.3269 (0.81) 2.3222 (0.63)
2.3179 (0.39) 2.1391 (2.16) 2.0693 (13.84) 2.0554 (1.06) 2.0398 (1.15) 2.0098 (2.75) 1.9949 (3.45)
1.9867 (6.69) 1.9654 (2.88) 1.9278 (1.09) 1.9144 (1.28) 1.8972 (1.28) 1.8874 (1.39) 1.842 (1.03) 1.83
(1.1) 1.8102 (1.7) 1.8009 (1.98) 1.7729 (2.27) 1.7561 (1.83) 1.7473 (1.95) 1.7287 (2.55) 1.7057 (3.3)
1.694 (2.56) 1.6697 (1.69) 1.6551 (1.39) 1.6374 (1) 1.6142 (1.82) 1.5843 (1.89) 1.5588 (1.57) 1.5394
(1.69) 1.5073 (4.03) 1.49 (4.94) 1.4565 (4.8) 1.43 (4.31) 1.4047 (2.97) 1.374 (1.58) 1.3564 (2.34)
1.3314 (1.97) 1.3091 (2.08) 1.2796 (1.85) 1.2616 (2.53) 1.2378 (3.37) 1.2115 (2.07) 1.193 (2.7) 1.1752
(3.94) 1.1574 (3.63) 1.1384 (3.11) 1.1191 (2.84) 1.0962 (2.26) 1.0793 (1.45) 1.0605 (1.16) 1.0414
(2.17) 1.014 (1.93) 0.9807 (0.35) 0.9251 (2.65) 0.9039 (13.38) 0.8875 (16) 0.882 (12.68) 0.8756
(12.02) 0.8652 (11.57) 0.8597 (15.81) 0.8432 (7.39) 0.8181 (1.55) 0.8018 (1.21) 0.7603 (0.35) 0.008
(1.24) −0.0002 (29.25) −0.0085 (1.23)
LogP^{[b]} = 4.87
Example 2
DMSO-d₆
7.2645 (1.19) 7.2432 (1.23) 7.2014 (0.42) 7.1804 (0.35) 7.1357 (1.28) 7.1144 (1.23) 4.077 (0.37)
4.0246 (1.08) 4.0134 (1.14) 3.9913 (0.88) 3.7282 (0.64) 3.7171 (0.48) 3.626 (12.34) 3.6158 (14.37)
3.5834 (0.39) 3.5091 (0.37) 3.4614 (0.41) 3.4361 (0.63) 3.4186 (0.77) 3.2991 (1273.96) 3.1921 (1.28)
3.1641 (0.88) 3.1486 (0.8) 3.0773 (0.72) 3.0583 (0.5) 3.0199 (0.4) 3.0015 (0.41) 2.9988 (0.39) 2.9804
(0.38) 2.9489 (0.35) 2.9231 (0.34) 2.8859 (0.33) 2.8679 (0.34) 2.8137 (0.33) 2.7992 (0.33) 2.7759
(0.35) 2.7645 (0.38) 2.7523 (0.36) 2.7468 (0.38) 2.7437 (0.37) 2.7398 (0.41) 2.6687 (3.98) 2.6643
(2.94) 2.6585 (3.12) 2.6508 (4.24) 2.6393 (5.24) 2.6328 (4.9) 2.6206 (5.21) 2.6019 (2.51) 2.5382 (7.54)
2.5036 (298.37) 2.4995 (363.9) 2.4955 (258.7) 2.3543 (0.69) 2.3304 (2.31) 2.3262 (2.83) 2.3217 (2.18)
2.2912 (0.45) 2.2842 (0.43) 2.2564 (0.38) 2.2372 (0.39) 2.2111 (0.4) 2.1933 (0.41) 2.131 (2.09) 2.1041
(0.53) 2.0857 (0.75) 2.069 (3.07) 2.0545 (1.13) 2.041 (1.04) 2.0056 (2.53) 1.9926 (3.08) 1.9635 (2.49)
1.9057 (1.08) 1.8957 (1.02) 1.8861 (1) 1.8634 (0.69) 1.8301 (1.13) 1.8215 (1.2) 1.802 (1.95) 1.7924
(2.18) 1.7701 (2.4) 1.7175 (2.12) 1.6952 (2.71) 1.653 (0.77) 1.6132 (1.46) 1.585 (1.69) 1.5588 (1.38)
1.5407 (1.17) 1.5062 (3.67) 1.4846 (4.22) 1.4633 (3.18) 1.4488 (3.4) 1.4412 (3.58) 1.4257 (3.74)
1.3989 (3.32) 1.3654 (1.13) 1.3373 (1.21) 1.3293 (1.28) 1.3076 (1.65) 1.2996 (1.59) 1.277 (1.39)
1.2574 (2.78) 1.2317 (2.97) 1.2072 (1.61) 1.1767 (1.93) 1.1572 (2.7) 1.1354 (2.96) 1.1183 (6.89)
1.0998 (16) 1.0813 (15.35) 1.0628 (5.53) 1.0386 (1.83) 1.0088 (1.6) 0.9811 (0.37) 0.9041 (8.74) 0.8821
(14.91) 0.8657 (13.05) 0.8568 (8.66) 0.8406 (6.93) 0.8205 (1.01) 0.8046 (0.81) 0.7954 (0.39) 0.7847
(0.37) −0.0002 (6.72)
LogP^{[b]} = 4.91
Example 3
DMSO-d₆
7.1924 (0.46) 7.1717 (0.51) 7.1141 (0.46) 7.0894 (0.33) 7.04 (0.84) 7.0186 (0.77) 5.3251 (0.39) 4.0278
(0.59) 4.0122 (0.73) 3.9981 (0.69) 3.6608 (0.37) 3.6159 (4.73) 3.6068 (11.05) 3.541 (0.5) 3.4354 (0.93)
3.4178 (1.19) 3.4007 (1.54) 3.3101 (2835.41) 3.2865 (24.96) 2.7095 (0.36) 2.6741 (1.31) 2.6694 (1.91)
2.6646 (1.32) 2.5394 (86.76) 2.5092 (107.4) 2.5048 (202.5) 2.5003 (266.67) 2.4959 (184.45) 2.4914
(88.69) 2.4186 (0.43) 2.3648 (0.49) 2.3316 (1.34) 2.327 (1.94) 2.3227 (1.42) 2.2043 (6.99) 2.1942 (16)
2.1342 (0.65) 2.0691 (2.68) 2.0102 (2.07) 1.9917 (1.72) 1.9635 (1.83) 1.9383 (0.46) 1.9072 (0.65)
1.8896 (0.7) 1.8392 (0.72) 1.8305 (0.6) 1.8099 (1.11) 1.8007 (1.25) 1.7676 (1.37) 1.6945 (0.91) 1.6486
(0.38) 1.617 (0.48) 1.5895 (0.66) 1.5629 (0.46) 1.5073 (1.33) 1.4909 (1.98) 1.482 (2.02) 1.4566 (2.14)
1.4209 (1.89) 1.3977 (1.15) 1.3646 (0.5) 1.3276 (0.87) 1.298 (1.29) 1.2607 (2.61) 1.236 (5.65) 1.2068
(1.23) 1.1558 (0.97) 1.1379 (1.13) 1.1205 (0.89) 1.1006 (0.66) 1.0375 (0.6) 1.0076 (0.54) 0.9034 (4.7)
0.8875 (5.59) 0.8819 (6.48) 0.862 (8.83) 0.8454 (5.43) 0.8218 (0.7) 0.8043 (0.55) 0.008 (0.88) −0.0002
(21.54) −0.0085 (0.98)
LogP^{[b]} = 4.43
Example 4
DMSO-d₆
7.7862 (1.3) 7.7652 (1.38) 7.6496 (0.34) 7.6282 (0.73) 7.6057 (0.74) 7.1552 (2.79) 7.1476 (0.64)
7.0199 (6) 7.0125 (1.27) 6.8848 (3.12) 6.8777 (0.68) 4.059 (0.76) 4.047 (0.78) 4.0378 (0.97) 4.0274
(1.01) 4.0176 (0.83) 4.0072 (0.74) 3.996 (0.66) 3.9872 (0.47) 3.8625 (16) 3.8524 (11.04) 3.3028
(522.15) 3.2792 (7.35) 2.7089 (0.65) 2.6734 (0.49) 2.6689 (0.59) 2.6642 (0.45) 2.5389 (159.92) 2.5221
(2.7) 2.5087 (31.8) 2.5043 (59.93) 2.4998 (79.09) 2.4954 (55.11) 2.4909 (26.86) 2.365 (0.64) 2.331
(0.47) 2.3266 (0.61) 2.3223 (0.48) 2.2046 (2.09) 2.1985 (2.06) 2.0692 (2.8) 2.0356 (1) 2.0203 (0.79)
1.9897 (2.69) 1.9668 (1.63) 1.9121 (0.48) 1.8849 (0.47) 1.8466 (0.56) 1.8098 (1.07) 1.7966 (1.19)
1.7789 (1.41) 1.7689 (1.57) 1.7567 (1.46) 1.7503 (1.41) 1.7265 (2.01) 1.7016 (1.69) 1.6897 (1.31)
1.6562 (0.62) 1.5961 (1.45) 1.5657 (1.67) 1.5416 (1.51) 1.5222 (1.88) 1.5042 (2.93) 1.4893 (3.4) 1.456
(2.84) 1.4449 (2.66) 1.434 (2.87) 1.4016 (1.84) 1.3796 (0.7) 1.3668 (0.79) 1.3146 (1.11) 1.2574 (2.12)
1.2367 (3.3) 1.2151 (1.32) 1.1876 (1.27) 1.1758 (1.24) 1.1575 (2.31) 1.1347 (2.18) 1.1183 (1.8) 1.0963
(1.44) 1.0783 (0.65) 1.0493 (1.87) 1.02 (1.65) 0.9084 (8.37) 0.8971 (11.92) 0.8927 (10.56) 0.8818
(13.68) 0.8657 (5.37) 0.8597 (5.17) 0.8434 (4.24) 0.8304 (0.79) 0.8139 (0.57) 0.0079 (0.94) −0.0002
(19.35) −0.0085 (0.69)
LogP^{[b]} = 5.10
Example 5
<CD3CN>
7.9241 (0.95) 7.9235 (0.96) 7.9095 (0.54) 3.8943 (4.49) 3.8869 (1.37) 3.8833 (2.66) 2.5186 (16) 2.3254
(14.25) 2.1843 (0.48) 2.1789 (0.45) 2.0349 (0.46) 2.0296 (0.5) 1.9552 (0.89) 1.9511 (1.62) 1.947 (2.3)
1.9429 (1.55) 1.9387 (0.81) 1.7749 (0.34) 1.7533 (0.37) 1.5759 (0.37) 1.5585 (0.57) 1.5568 (0.59)
1.5503 (0.54) 1.548 (0.62) 1.5456 (0.72) 1.5389 (0.91) 1.5345 (0.73) 1.5307 (0.61) 1.518 (0.52) 1.5115
(0.33) 1.4992 (0.91) 1.4971 (0.89) 1.4939 (0.7) 1.4863 (0.69) 1.4813 (0.97) 1.1876 (0.53) 1.1843 (0.51)
1.1717 (0.55) 1.1559 (0.53) 1.1433 (0.37) 1.14 (0.4) 1.0936 (0.43) 1.0743 (0.41) 0.9312 (0.99) 0.9283
(2.82) 0.9231 (0.94) 0.9202 (1.11) 0.9176 (2.84) 0.9123 (0.81) 0.9054 (2.9) 0.9018 (1.93) 0.8948 (2.83)
0.8909 (1.83) 0.8863 (0.47) 0.8833 (1.75) 0.8753 (0.38) 0.8724 (1.66) −0.0002 (0.81)
LogP^{[b]} = 4.64
Example 6
DMSO-d₆
8.6014 (0.84) 8.58 (0.9) 8.4765 (0.61) 8.4548 (0.61) 4.0262 (0.62) 4.0058 (0.64) 3.9963 (0.8) 3.9761
(0.57) 3.9641 (0.5) 3.3048 (1104.21) 3.2811 (13.14) 2.7135 (16) 2.702 (10.71) 2.6736 (0.94) 2.6689
(1.13) 2.6645 (0.89) 2.5894 (0.63) 2.539 (190.71) 2.5087 (55.82) 2.5043 (104.39) 2.4998 (137.24)
2.4954 (94.38) 2.491 (45.04) 2.3656 (0.77) 2.3312 (0.81) 2.3265 (1.05) 2.3221 (0.78) 2.1284 (1.4)
2.0691 (1.59) 2.0612 (0.5) 2.0455 (0.67) 2.0296 (0.95) 1.9975 (2.48) 1.9662 (1.41) 1.9082 (0.46)
1.7865 (1.23) 1.7567 (1.44) 1.7279 (1.58) 1.701 (1.15) 1.6876 (1) 1.6597 (0.53) 1.5807 (1.01) 1.5498
(1.51) 1.5226 (1.89) 1.4982 (2.23) 1.4884 (1.86) 1.4794 (1.96) 1.4624 (2.09) 1.4453 (1.85) 1.4262
(1.79) 1.4002 (1.24) 1.3382 (0.98) 1.3165 (0.92) 1.2372 (2.92) 1.2027 (0.82) 1.1756 (1.14) 1.1588
(1.61) 1.1333 (1.42) 1.103 (1.01) 1.0794 (0.97) 1.0609 (1.47) 1.0323 (1.13) 0.909 (5.42) 0.8933 (11.16)
0.878 (7.59) 0.8656 (5.18) 0.8544 (1.63) 0.8471 (3.25) 0.8173 (0.35) 0.0079 (1.04) −0.0002 (20.84) −0.0085
(0.63)
LogP^{[b]} = 5.23
Example 7
DMSO-d₆
8.3209 (0.87) 8.3011 (0.89) 8.2449 (0.38) 8.214 (0.83) 8.1934 (0.8) 7.422 (0.88) 7.4012 (1.21) 7.2863
(1.92) 7.2656 (2.78) 7.1511 (0.93) 7.1302 (1.37) 4.0906 (0.55) 4.0773 (0.55) 4.06 (0.71) 4.0432 (0.66)
3.3046 (838.67) 3.281 (8.74) 3.2499 (0.38) 2.7119 (14.62) 2.7023 (16) 2.6784 (0.46) 2.6738 (0.69)
2.6693 (0.85) 2.6645 (0.66) 2.5392 (217.38) 2.5224 (3.89) 2.509 (45.85) 2.5046 (85.61) 2.5001
(111.89) 2.4957 (77.2) 2.4912 (36.81) 2.3657 (0.73) 2.3314 (0.57) 2.3267 (0.72) 2.322 (0.53) 2.0871
(1.4) 2.0694 (1.5) 2.0552 (0.56) 2.0408 (0.63) 2.0269 (0.77) 2.0105 (1.06) 1.991 (2.32) 1.9697 (2.81)
1.9331 (0.51) 1.8903 (0.72) 1.8618 (0.63) 1.8521 (0.56) 1.8315 (0.56) 1.822 (0.54) 1.8048 (0.79)
1.7768 (1.17) 1.7606 (0.91) 1.751 (0.92) 1.7374 (1.11) 1.7093 (1.7) 1.6873 (0.85) 1.6701 (1.27) 1.64
(1.03) 1.6145 (0.58) 1.5417 (0.8) 1.5081 (1.94) 1.4913 (2.78) 1.4616 (2.86) 1.4232 (1.66) 1.4057 (1.22)
1.3973 (1.04) 1.3719 (0.57) 1.3605 (0.56) 1.3322 (1.15) 1.3071 (1.36) 1.2634 (2.35) 1.2375 (4.28)
1.2149 (1.07) 1.1834 (0.77) 1.1653 (1.21) 1.1599 (1.21) 1.1407 (1.38) 1.1221 (1.16) 1.0974 (0.92)
1.0794 (0.42) 1.0503 (1.11) 1.0217 (1.01) 0.9076 (5.91) 0.8916 (6.42) 0.8816 (9.36) 0.8654 (9.56)
0.8612 (6.67) 0.8445 (4.55) 0.824 (0.67) 0.8078 (0.53) 0.008 (1.09) −0.0002 (26.08) −0.0084 (1.04)
LogP^{[b]} = 5.04
Example 8
DMSO-d₆
20.0082 (0.77) 8.2078 (1.97) 8.1861 (2.19) 8.126 (0.68) 8.1003 (0.77) 8.087 (1.64) 8.0646 (1.71)
7.7688 (2.66) 7.7494 (6.33) 7.7315 (4.49) 7.7149 (4.25) 7.6956 (4.53) 7.6751 (2.1) 7.6422 (2.37)
7.6232 (4.5) 7.6075 (3.72) 7.5879 (1.42) 7.4414 (3.41) 7.4233 (3.37) 7.411 (2.97) 7.3924 (2.56) 5.3232
(0.7) 4.0645 (1.58) 4.0476 (2.08) 4.0334 (2.14) 4.0151 (1.68) 3.9835 (0.7) 3.4353 (0.73) 3.3105
(5955.7) 3.287 (61.14) 3.0943 (1.33) 2.9867 (1.06) 2.7787 (0.86) 2.7094 (1.94) 2.6738 (3.49) 2.6695
(4.15) 2.6646 (3.37) 2.5393 (363.95) 2.5091 (230.25) 2.5047 (426.93) 2.5003 (556.7) 2.4959 (388.51)
2.4915 (187.38) 2.365 (1.75) 2.3315 (2.95) 2.327 (3.89) 2.3224 (3.08) 2.2223 (3.46) 2.1121 (1.31)
2.0824 (4.54) 2.0689 (7.74) 2.0561 (1.34) 2.0302 (1.53) 1.994 (4.75) 1.9681 (4.05) 1.8797 (1.84)
1.7949 (3.54) 1.7718 (3.4) 1.7636 (3.22) 1.7166 (2.86) 1.7029 (2.69) 1.6104 (3.14) 1.5796 (4.2) 1.5553
(3.46) 1.5338 (2.81) 1.5079 (5.63) 1.4849 (5.13) 1.4467 (6.83) 1.421 (3.96) 1.3872 (1.61) 1.3502 (2.88)
1.3304 (2.76) 1.2372 (9.8) 1.1576 (4.12) 1.1327 (3.95) 1.1121 (3) 1.0879 (2.61) 1.0689 (3.73) 1.0396
(2.96) 0.9343 (13.29) 0.9228 (16) 0.9188 (15.97) 0.9072 (13.03) 0.896 (9.28) 0.8876 (12.04) 0.8796
(12.36) 0.8752 (14.82) 0.8717 (13.68) 0.8591 (10.76) −0.0002 (37.77) −0.0085 (1.31)
LogP^{[b]} = 5.25
Example 9
DMSO-d₆
8.4589 (5.17) 8.454 (5.74) 8.4469 (6.68) 8.4424 (7.56) 8.4385 (4.07) 8.4312 (4.28) 8.4264 (3) 8.3151
(2.55) 8.2942 (2.67) 8.268 (0.34) 8.2224 (0.71) 8.1908 (1.53) 8.17 (1.43) 7.8173 (5.2) 7.8124 (5.4)
7.8023 (3.77) 7.7984 (7.94) 7.7937 (6.48) 7.7836 (3.56) 7.7787 (3.53) 7.7722 (1.45) 7.4907 (5.83)
7.4787 (7.14) 7.4718 (7.91) 7.467 (2.28) 7.4598 (8.59) 7.4524 (3.25) 7.4482 (1.52) 7.4404 (2.9) 5.325
(0.4) 4.1077 (0.6) 4.0947 (0.66) 4.0764 (1.74) 4.0651 (1.64) 4.0571 (1.7) 4.0436 (2.37) 4.0294 (1.46)
4.013 (1.41) 3.9776 (0.35) 3.4358 (0.41) 3.3948 (0.77) 3.376 (1.25) 3.3102 (2160.79) 3.2868 (20.28)
3.2169 (0.85) 3.2022 (0.75) 3.1772 (0.54) 3.128 (0.39) 3.1078 (0.36) 3.0858 (0.33) 2.7092 (1.43)
2.6738 (1.13) 2.6693 (1.46) 2.6648 (1.06) 2.6057 (0.39) 2.5918 (0.55) 2.5393 (397.58) 2.5091 (83.67)
2.5047 (155.36) 2.5002 (202.58) 2.4958 (140.39) 2.4914 (67.62) 2.4246 (0.55) 2.3929 (0.38) 2.3823
(0.35) 2.3653 (1.51) 2.3316 (1.19) 2.3268 (1.53) 2.3224 (1.21) 2.2884 (4.23) 2.2819 (4.03) 2.1592
(0.35) 2.1291 (3.02) 2.0994 (1.67) 2.084 (2.06) 2.069 (4.02) 2.0549 (1.28) 2.0378 (0.83) 2.0286 (0.9)
2.0065 (4.74) 1.9993 (4.82) 1.9748 (3.52) 1.9486 (0.82) 1.9175 (1.26) 1.9054 (1.46) 1.877 (1.68)
1.8487 (1.85) 1.8403 (1.83) 1.8193 (2.23) 1.8103 (2.28) 1.7922 (2.88) 1.7631 (2.45) 1.7537 (2.51)
1.7335 (3.19) 1.7219 (3.44) 1.7089 (2.98) 1.6955 (2.48) 1.6798 (1.42) 1.652 (0.93) 1.6357 (1.2) 1.6119
(1.44) 1.5896 (4.02) 1.5639 (3.66) 1.547 (2.18) 1.5323 (4.46) 1.513 (5.81) 1.5051 (5.41) 1.4885 (5.4)
1.4706 (6.14) 1.4514 (6.68) 1.4215 (4.22) 1.4012 (1.4) 1.3873 (1.6) 1.3522 (2.47) 1.3357 (2.16) 1.2982
(1.84) 1.26 (4.01) 1.2367 (7.22) 1.2085 (2.34) 1.18 (3.24) 1.1638 (4.55) 1.1379 (3.69) 1.1168 (2.99)
1.0912 (3) 1.0741 (4.44) 1.0449 (3.44) 0.9511 (15.69) 0.9353 (16) 0.9239 (15.85) 0.9079 (15.63) 0.9
(9.01) 0.8868 (12.22) 0.8735 (13.53) 0.8577 (9.71) 0.8367 (0.9) 0.0081 (0.73) −0.0002 (16.11) −0.0087
(0.65)
LogP^{[b]} = 4.33

Intensity of sharp signals correlates with the height of the signals in a printed example of a NMR spectrum in cm and shows the real relations of signal intensities. From broad signals several peaks or the middle of the signal and their relative intensity in comparison to the most intensive signal in the spectrum can be shown

The 1H-NMR peak lists are similar to classical 1H-NMR prints and contain therefore usually all peaks, which are listed at classical NMR-interpretation.

Additionally they can show like classical 1H-NMR prints signals of solvents, stereoisomers of the target compounds, which are also object of the invention, and/or peaks of impurities.

To show compound signals in the delta-range of solvents and/or water the usual peaks of solvents, for example peaks of DMSO in DMSO-d6 and the peak of water are shown in our 1H-NMR peak lists and have usually on average a high intensity.

The peaks of stereoisomers of the target compounds and/or peaks of impurities have usually on average a lower intensity than the peaks of target compounds (for example with a purity>90%).

Such stereoisomers and/or impurities can be typical for the specific preparation process. Therefore their peaks can help to recognize the reproduction of our preparation process via “side-products-fingerprints”.

An expert, who calculates the peaks of the target compounds with known methods (MestreC, ACD-simulation, but also with empirically evaluated expectation values) can isolate the peaks of the target compounds as needed optionally using additional intensity filters. This isolation would be similar to relevant peak picking at classical 1H-NMR interpretation.

Measurement of log P values was performed according EEC directive 79/831 Annex V.A8 by HPLC (High Performance Liquid Chromatography) on reversed phase columns with the following methods:

^{[b]} measurement of LC-MS was done at pH 2.7 with 0.1% formic acid in water and with acetonitrile (contains 0.1% formic acid) as eluent with a linear gradient from 10% acetonitrile to 95% acetonitrile.

Calibration was done with not branched alkan2-ones (with 3 to 16 carbon atoms) with known log P-values (measurement of log P values using retention times with linear interpolation between successive alkanones). lambda-maX-values were determined using UV-spectra from 200 nm to 400 nm and the peak values of the chromatographic signals.

In table 1, M+H (or M H) means the molecular ion peak, plus or minus 1 a.m.u. (atomic mass unit) respectively, as observed in mass spectroscopy and M (ApcI+) means the molecular ion peak as it was found via positive atmospheric pressure chemical ionisation in mass spectroscopy.

### EXAMPLE

### Sphaerotheca Test (Cucumber)/Preventive

| | |
|---|---|
| Solvent: | 49 parts by weight of N,N-Dimethylformamide |
| Emulsifier: | 1 part by weight of Alkylarylpolyglycolether |

To produce a suitable preparation of active compound, 1 part by weight of active compound is mixed with the stated amounts of solvent and emulsifier, and the concentrate is diluted with water to the desired concentration.

To test for preventive activity, young plants are sprayed with the preparation of active compound at the stated rate of application. One day after this treatment, the plants are inoculated with an aqueous spore suspension of Sphaerotheca fuliginea. Then the plants are placed in a greenhouse at approximately 23° C. and a relative atmospheric humidity of approximately 70%.

The test is evaluated 7 days after the inoculation. 0% means an efficacy which corresponds to that of the untreated control, while an efficacy of 100% means that no disease is observed.

In this test the following compounds according to the invention showed efficacy of 70% or even higher at a concentration of 500 ppm of active ingredient.

| Example # | Eff. % |
|---|---|
| 1 | 100 |
| 2 | 88 |
| 4 | 88 |
| 3 | 85 |

### EXAMPLE

### Alternaria Test (Tomato)/Preventive

| | |
|---|---|
| Solvent: | 49 parts by weight of N,N-Dimethylformamide |
| Emulsifier: | 1 part by weight of Alkylarylpolyglycolether |

To produce a suitable preparation of active compound, 1 part by weight of active compound is mixed with the stated amounts of solvent and emulsifier, and the concentrate is diluted with water to the desired concentration.

To test for preventive activity, young plants are sprayed with the preparation of active compound at the stated rate of application. One day after this treatment, the plants are inoculated with an aqueous spore suspension of Alternaria solani. The plants remain for one day in an incubation cabinet at approximately 22° C. and a relative atmospheric humidity of 100%. Then the plants are placed in an incubation cabinet at approximately 20° C. and a relative atmospheric humidity of 96%.

The test is evaluated 7 days after the inoculation. 0% means an efficacy which corresponds to that of the untreated control while an efficacy of 100% means that no disease is observed.

In this test the following compounds according to the invention showed efficacy of 70% or even higher at a concentration of 500 ppm of active ingredient.

| Example # | Eff. % |
|---|---|
| 1 | 95 |
| 3 | 94 |
| 4 | 94 |
| 6 | 89 |

### EXAMPLE

### Pyrenophora Test (Barley)/Preventive

| | |
|---|---|
| Solvent: | 49 parts by weight of N,N-Dimethylformamide |
| Emulsifier: | 1 part by weight of Alkylarylpolyglycolether |

To produce a suitable preparation of active compound, 1 part by weight of active compound is mixed with the stated amounts of solvent and emulsifier, and the concentrate is diluted with water to the desired concentration.

To test for preventive activity, young plants are sprayed with the preparation of active compound at the stated rate of application. One day after this treatment, the plants are inoculated with an aqueous spore suspension of Pyrenophora teres. The plants remain for 48 hours in an incubation cabinet at 22° C. and a relative atmospheric humidity of 100%. Then the plants are placed in a greenhouse at a temperature of approximately 20° C. and a relative atmospheric humidity of approximately 80%.

The test is evaluated 7-9 days after the inoculation. 0% means an efficacy which corresponds to that of the untreated control while an efficacy of 100% means that no disease is observed.

In this test the following compounds according to the invention showed efficacy of 70% or even higher at a concentration of 500 ppm of active ingredient.

| Example # | Eff. % |
|---|---|
| 1 | 100 |
| 2 | 70 |
| 3 | 100 |
| 4 | 100 |
| 5 | 70 |
| 7 | 95 |

### EXAMPLE

### Puccinia Test (Wheat)/Preventive

| | |
|---|---|
| Solvent: | 49 parts by weight of N,N-Dimethylformamide |
| Emulsifier: | 1 part by weight of Alkylarylpolyglycolether |

To produce a suitable preparation of active compound, 1 part by weight of active compound is mixed with the stated amounts of solvent and emulsifier, and the concentrate is diluted with water to the desired concentration.

To test for preventive activity, young plants are sprayed with the preparation of active compound at the stated rate of application. One day after this treatment, the plants are inoculated with an aqueous spore suspension of Puccinia recondita. The plants remain for 48 hours in an incubation cabinet at 22° C. and a relative atmospheric humidity of 100%. Then the plants are placed in a greenhouse at a temperature of approximately 20° C. and a relative atmospheric humidity of approximately 80%.

The test is evaluated 7-9 days after the inoculation. 0% means an efficacy which corresponds to that of the untreated control while an efficacy of 100% means that no disease is observed.

In this test the following compounds according to the invention showed efficacy of 70% or even higher at a concentration of 500 ppm of active ingredient.

| Example # | Eff. % |
|---|---|
| 1 | 95 |
| 3 | 80 |
| 4 | 80 |

### EXAMPLE

### Venturia Test (Apples)/Preventive

| | |
|---|---|
| Solvent: | 24.5 parts by weight of acetone |
| | 24.5 parts by weight of dimethylacetamide |
| Emulsifier: | 1 part by weight of alkylaryl polyglycol ether |

To produce a suitable preparation of active compound, 1 part by weight of active compound is mixed with the stated amounts of solvent and emulsifier, and the concentrate is diluted with water to the desired concentration.

To test for preventive activity, young plants are sprayed with the preparation of active compound at the stated rate of application. After the spray coating has dried on, the plants are inoculated with an aqueous conidia suspension of the causal agent of apple scab (Venturia inaequalis) and then remain for 1 day in an incubation cabinet at approximately 20° C. and a relative atmospheric humidity of 100%.

The plants are then placed in a greenhouse at approximately 21° C. and a relative atmospheric humidity of approximately 90%.

The test is evaluated 10 days after the inoculation. 0% means an efficacy which corresponds to that of the untreated control, while an efficacy of 100% means that no disease is observed.

In this test the following compounds according to the invention showed efficacy of 70% or even higher at a concentration of 100 ppm of active ingredient.

| Example # | Eff. % |
|---|---|
| 1 | 100 |

### EXAMPLE

### Blumeria Test (Barley)/Preventive

| | |
|---|---|
| Solvent: | 49 parts by weight of n,n-dimethylacetamid |
| Emulsifier: | 1 part by weight of alkylaryl polyglycol ether |

To produce a suitable preparation of active compound, 1 part by weight of active compound or active compound combination is mixed with the stated amounts of solvent and emulsifier, and the concentrate is diluted with water to the desired concentration.

To test for preventive activity, young plants are sprayed with the preparation of active compound or active compound combination at the stated rate of application.

After the spray coating has been dried, the plants are dusted with spores of Blumeria graminis f.sp. hordei.

The plants are placed in the greenhouse at a temperature of approximately 18° C. and a relative atmospheric humidity of approximately 80% to promote the development of mildew pustules.

The test is evaluated 7 days after the inoculation. 0% means an efficacy which corresponds to that of the untreated control, while an efficacy of 100% means that no disease is observed.

In this test the following compounds according to the invention showed an efficacy of 70% or even higher at a concentration of 500 ppm of active ingredient.

| Example # | Eff. % |
|---|---|
| 1 | 100 |

### EXAMPLE

### Septoria Tritici-Test (Wheat)/Preventive

| | |
|---|---|
| Solvent: | 49 parts by weight of n,n-dimethylacetamid |
| Emulsifier: | 1 part by weight of alkylaryl polyglycol ether |

To produce a suitable preparation of active compound, 1 part by weight of active compound or active compound combination is mixed with the stated amounts of solvent and emulsifier, and the concentrate is diluted with water to the desired concentration.

To test for preventive activity, young plants are sprayed with the preparation of active compound or active compound combination at the stated rate of application.

After the spray coating has been dried, the plants are sprayed with a spore suspension of Septoria tritici. The plants remain for 48 hours in an incubation cabinet at approximately 20° C. and a relative atmospheric humidity of approximately 100% and afterwards for 60 hours at approximately 15° C. in a translucent incubation cabinet at a relative atmospheric humidity of approximately 100%.

The plants are placed in the greenhouse at a temperature of approximately 15° C. and a relative atmospheric humidity of approximately 80%.

The test is evaluated 21 days after the inoculation. 0% means an efficacy which corresponds to that of the untreated control, while an efficacy of 100% means that no disease is observed.

In this test the following compounds according to the invention showed an efficacy of 70% or even higher at a concentration of 500 ppm of active ingredient.

| Example # | Eff. % |
|---|---|
| 1 | 90 |

1. A decahydro-1,4-methanonaphthalen carboxamide compound according to formula (Ia) or (Ib) 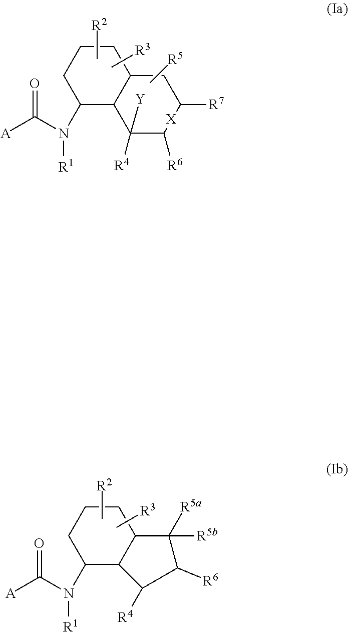
wherein
X is a single or double bond;
Y is O, S, N(R¹¹) or (CR¹²R¹³)(CR¹⁴R¹⁵)ₘ(CR¹⁶R¹⁷)ₙ;
m is 0 or 1;
n is 0 or 1;
R¹ is hydrogen, C₁₋₄ alkyl, C₁₋₄ haloalkyl, C₁₋₄ alkoxy, C₁₋₄ haloalkoxy, CH₂C≡CR⁸, CH₂CR^{9a}═CHR^{9b}, CH═C═CH₂ or COR¹⁰;
R² and R³ are each, independently, hydrogen, halogen, C₁₋₄ alkyl, C₁₋₄ alkoxy or C₁₋₄ haloalkoxy;
R⁴, R⁵, R⁶, R⁷, R^{5a} and R^{5b} are each, independently, hydrogen, halogen, C₁₋₄ alkyl, C₁₋₄ haloalkyl, C₁₋₄ alkoxy, C₁₋₄ haloalkoxy, C₁₋₄ alkylthio, C₁₋₄ haloalkylthio, hydroxymethyl, C₁₋₄ alkoxymethyl, C(O)CH₃ or C(O)OCH₃;
R⁸, R^{9a} and R^{9b} are each, independently, hydrogen, halogen, C₁₋₄ alkyl, C₁₋₄ haloalkyl or C₁₋₄ alkoxy(C₁₋₄)alkylene;
and R¹⁰ is hydrogen, C₁₋₆ alkyl, C₁₋₆ haloalkyl, C₁₋₄ alkoxy(C₁₋₄) alkylene, C₁₋₄ alkyl-S— (C₁₋₄) alkylene, C₁₋₄ alkoxy or aryl;
R¹¹ is hydrogen, C₁₋₄ alkyl, benzyl wherein the phenyl group is optionally substituted with up to three substituents, each independently selected from halogen, C₁₋₄ alkyl, C₁₋₄ haloalkyl and C₁₋₄ alkoxy, formyl, C(O)C₁₋₄ alkyl optionally substituted by halogen or C₁₋₄ alkoxy, C(═O)O—C₁₋₆ alkyl optionally substituted by halogen, C₁₋₄ alkoxy or cyano or C₁₋₄ alkoxy(C₁₋₄)alkylene;
R¹², R¹³, R¹⁴, R¹⁵, R¹⁶ and R¹⁷ are each, independently, hydrogen, halogen, hydroxy, C₁₋₆ alkyl, C₂₋₆ alkenyl [both optionally substituted by halogen, hydroxy, C₁₋₄ alkoxy, ═O, aryl or O—C(O)—C₁₋₄ alkyl or a 3-7 membered carboxylic ring itself optionally substituted by up to three methyl groups, a 3-7 membered saturated ring optionally substituted by up to three methyl groups and optionally containing one heteroatom selected from nitrogen and oxygen or C₁₋₄ alkoxy;
or R¹² and R¹³ together with the carbon atom to which they are attached form the group C═O or a 3-5 membered carbocyclic ring optionally substituted by up to three methyl groups and optionally with up to 2 heteroatoms each independently selected from O and N;
or R¹² and R¹³ together form a C₁₋₆ alkylidene optionally substituted by up to three methyl groups or a C₃₋₆ cycloalkylidene group optionally substituted by up to three methyl groups;
A represents one of the radicals A1 to A18 below 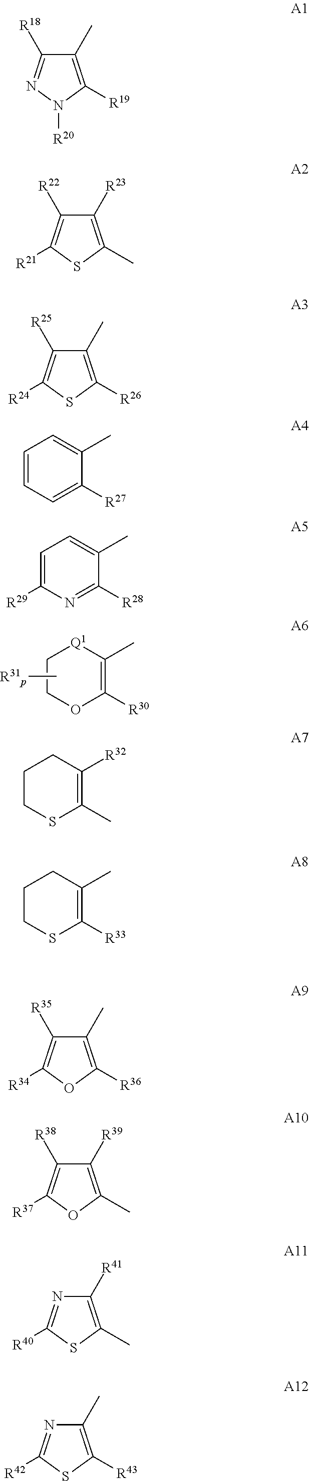 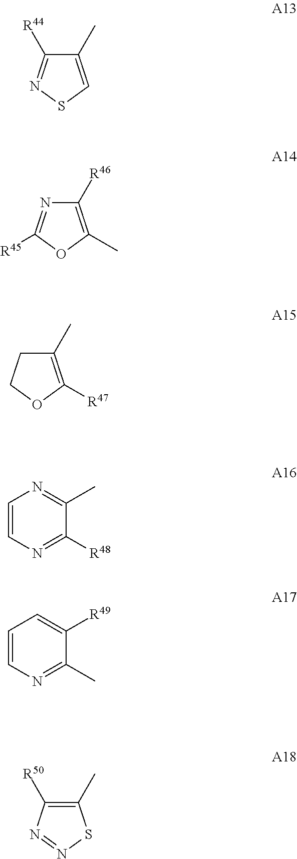
R¹⁸ represents hydrogen, cyano, halogen, nitro, C₁-C₄-alkyl, C₁-C₄-alkoxy, C₁₋₄-alkylthio, C₃-C₆-cycloalkyl, C₁-C₄-haloalkyl, C₁-C₄-haloalkoxy or C₁-C₄-haloalkylthio comprising in each case 1 to 5 halogen atoms, aminocarbonyl or aminocarbonyl-C₁-C₄-alkyl,
R¹⁹ represents hydrogen, halogen, cyano, C₁-C₄-alkyl, C₁-C₄-alkoxy or C₁-C₄-alkylthio,
R²⁰ represents hydrogen, C₁-C₄-alkyl, hydroxy-C₁-C₄-alkyl, C₂-C₆-alkenyl, C₃-C₆-cycloalkyl, C₁-C₄-alkylthio-C₁-C₄-alkyl, C₁-C₄-alkoxy-C₁-C₄-alkyl, C₁-C₄-haloalkyl, C₁-C₄-haloalkylthio-C₁-C₄-alkyl, C₁-C₄-haloalkoxy-C₁-C₄-alkyl comprising in each case 1 to 5 halogen atoms, or phenyl,
R²¹ and R²² independently of one another represent hydrogen, halogen, C₁-C₄-alkyl or C₁-C₄-haloalkyl comprising 1 to 5 halogen atoms,
R²³ represents halogen, cyano or C₁-C₄-alkyl, or C₁-C₄-haloalkyl or C₁-C₄-haloalkoxy comprising in each case 1 to 5 halogen atoms,
R²⁴ and R²⁵ independently of one another represent hydrogen, halogen, C₁-C₄-alkyl or C₁-C₄-haloalkyl comprising 1 to 5 halogen atoms,
R²⁶ represents hydrogen, halogen, C₁-C₄-alkyl or C₁-C₄-haloalkyl comprising 1 to 5 halogen atoms,
R²⁷ represents halogen, hydroxyl, cyano, C₁-C₆-alkyl, C₁-C₄-haloalkyl, C₁-C₄-haloalkoxy or C₁-C₄-haloalkylthio comprising in each case 1 to 5 halogen atoms,
R²⁸ represents halogen, hydroxyl, cyano, C₁-C₄-alkyl, C₁-C₄-alkoxy, C₁-C₄-alkylthio, C₁-C₄-haloalkyl, C₁-C₄-haloalkylthio or C₁-C₄-haloalkoxy comprising in each case 1 to 5 halogen atoms,
R²⁹ represents hydrogen, halogen, cyano, C₁-C₄-alkyl, C₁-C₄-alkoxy, C₁-C₄-alkylthio, C₁-C₄-haloalkyl, C₁-C₄-haloalkoxy comprising in each case 1 to 5 halogen atoms, C₁-C₄-alkylsulphinyl or C₁-C₄-alkylsulphonyl,
R³⁰ represents C₁-C₄-alkyl or C₁-C₄-haloalkyl comprising 1 to 5 halogen atoms,
R³¹ represents C₁-C₄-alkyl,
Q¹ represents sulphur, SO, SO₂ or CH₂,
p represents 0, 1 or 2, wherein R³¹ represents identical or different radicals if p represents 2,
R³² represents C₁-C₄-alkyl or C₁-C₄-haloalkyl comprising 1 to 5 halogen atoms,
R³³ represents C₁-C₄-alkyl or C₁-C₄-haloalkyl comprising 1 to 5 halogen atoms,
R³⁴ and R³⁵ independently of one another represent hydrogen, halogen, amino, C₁-C₄-alkyl or C₁-C₄-haloalkyl comprising 1 to 5 halogen atoms,
R³⁶ represents hydrogen, halogen, C₁-C₄-alkyl or C₁-C₄-haloalkyl comprising 1 to 5 halogen atoms,
R³⁷ and R³⁸ independently of one another represent hydrogen, halogen, amino, nitro, C₁-C₄-alkyl or C₁-C₄-haloalkyl comprising 1 to 5 halogen atoms,
R³⁹ represents hydrogen, halogen, C₁-C₄-alkyl or C₁-C₄-haloalkyl comprising 1 to 5 halogen atoms,
R⁴⁰ represents hydrogen, halogen, amino, C₁-C₄-alkylamino, di-(C₁-C₄-alkyl)amino, cyano, C₁-C₄-alkyl or C₁-C₄-haloalkyl comprising 1 to 5 halogen atoms,
R⁴¹ represents halogen, C₁-C₄-alkyl or C₁-C₄-haloalkyl comprising 1 to 5 halogen atoms,
R⁴² represents hydrogen, halogen, amino, C₁-C₄-alkylamino, di-(C₁-C₄-alkyl)amino, cyano, C₁-C₄-alkyl or C₁-C₄-haloalkyl comprising 1 to 5 halogen atoms,
R⁴³ represents halogen, C₁-C₄-alkyl or C₁-C₄-haloalkyl comprising 1 to 5 halogen atoms,
R⁴⁴ represents halogen, C₁-C₄-alkyl or C₁-C₄-haloalkyl comprising 1 to 5 halogen atoms,
R⁴⁵ represents hydrogen or C₁-C₄-alkyl,
R⁴⁶ represents halogen or C₁-C₄-alkyl,
R⁴⁷ represents C₁-C₄-alkyl or C₁-C₄-haloalkyl comprising 1 to 5 halogen atoms,
R⁴⁸ represents hydrogen, halogen, C₁-C₄-alkyl or C₁-C₄-haloalkyl comprising 1 to 5 halogen atoms,
R⁴⁹ represents halogen, hydroxyl, C₁-C₄-alkyl, C₁-C₄-alkoxy, C₁-C₄-alkylthio, C₁-C₄-haloalkyl, C₁-C₄-haloalkylthio or C₁-C₄-haloalkoxy comprising in each case 1 to 5 halogen atoms,
R⁵⁰ represents C₁-C₄-alkyl.

2. The compound of formula (Ia) or (Ib) as claimed in claim 1 wherein Y is O, N(R¹¹) or (CR¹²R¹³)(CR¹4R¹⁵)ₘ(CR¹⁶R¹⁷)ₙ.

3. The compound of formula (Ia) or (Ib) as claimed in claim 1 wherein R¹ is hydrogen, CH₂C≡CR⁸, CH═C═CH₂ or COR¹⁰.

4. A compound of formula (Ic) 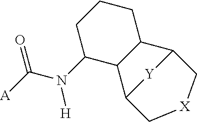
Wherein
X is a single or double bond;
Y is O, S, N(R¹¹) or (CR¹²R¹³)(CR¹⁴R¹⁵)ₘ(CR¹⁶R¹⁷)ₙ;
m is 0 or 1;
n is 0 or 1;
R¹ is hydrogen, C₁₋₄ alkyl, C₁₋₄ haloalkyl, C₁₋₄ alkoxy, C₁₋₄ haloalkoxy, CH₂C≡CR⁸, CH₂CR^{9a}═CHR^{9b}, CH═C═CH₂ or COR¹⁰;
R² and R³ are each, independently, hydrogen, halogen, C₁₋₄ alkyl, C₁₋₄ alkoxy or C₁₋₄ haloalkoxy;
R⁴, R⁵, R⁶, R⁷, R^{5a} and R^{5b} are each, independently, hydrogen, halogen, C₁₋₄ alkyl, C₁₋₄ haloalkyl, C₁₋₄ alkoxy, C₁₋₄ haloalkoxy, C₁₋₄ alkylthio, C₁₋₄ haloalkylthio, hydroxymethyl, C₁₋₄ alkoxymethyl, C(O)CH₃ or C(O)OCH₃;
R⁸, R^{9a} and R^{9b} are each, independently, hydrogen, halogen, C₁₋₄ alkyl, C₁₋₄ haloalkyl or C₁₋₄ alkoxy(C₁₋₄)alkylene;
and R¹⁰ is hydrogen, C₁₋₆ alkyl, C₁₋₆ haloalkyl, C₁₋₄ alkoxy(C₁₋₄) alkylene, C₁₋₄ alkyl-S— (C₁₋₄) alkylene, C₁₋₄ alkoxy or aryl;
R¹¹ is hydrogen, C₁₋₄ alkyl, benzyl wherein the phenyl group is optionally substituted with up to three substituents, each independently selected from halogen, C₁₋₄ alkyl, C₁₋₄ haloalkyl and C₁₋₄ alkoxy, formyl, C(O)C₁₋₄ alkyl optionally substituted by halogen or C₁₋₄ alkoxy, C(═O)O—C₁₋₆ alkyl optionally substituted by halogen, C₁₋₄ alkoxy or cyano or C₁₋₄ alkoxy(C₁₋₄)alkylene;
R¹², R¹³, R¹⁴, R¹⁵, R¹⁶ and R¹⁷ are each, independently, hydrogen, halogen, hydroxy, C₁₋₆ alkyl, C₂₋₆ alkenyl both optionally substituted by halogen, hydroxy, C₁₋₄ alkoxy, ═O, aryl or O—C(O)—C₁₋₄ alkyl or a 3-7 membered carboxylic ring itself optionally substituted by up to three methyl groups, a 3-7 membered saturated ring optionally substituted by up to three methyl groups and optionally containing one heteroatom selected from nitrogen and oxygen or C₁₋₄ alkoxy;
or R¹² and R¹³ together with the carbon atom to which they are attached form the group C═O or a 3-5 membered carbocyclic ring optionally substituted by up to three methyl groups and optionally with up to 2 heteroatoms each independently selected from O and N;
or R¹² and R¹³ together form a C₁₋₆ alkylidene optionally substituted by up to three methyl groups or a C₃₋₆ cycloalkylidene group optionally substituted by up to three methyl groups;
A represents one of the radicals A1 to A18 below 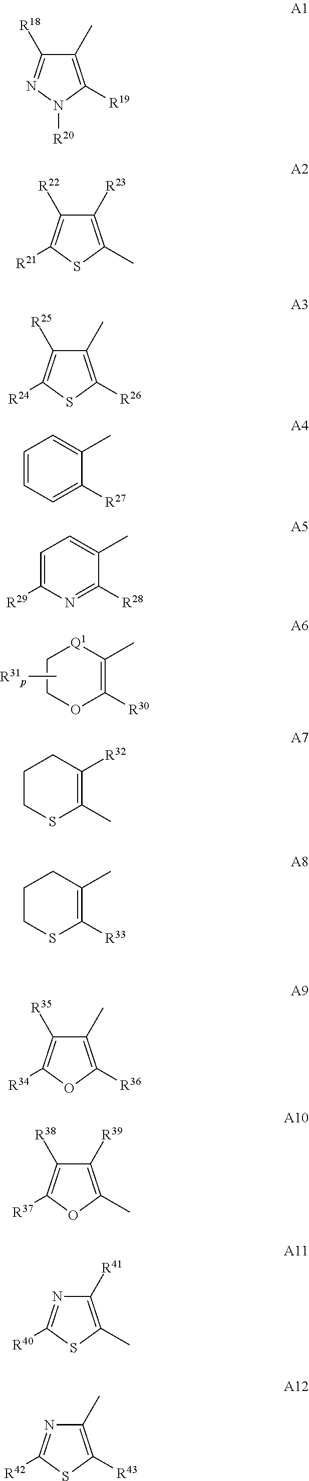 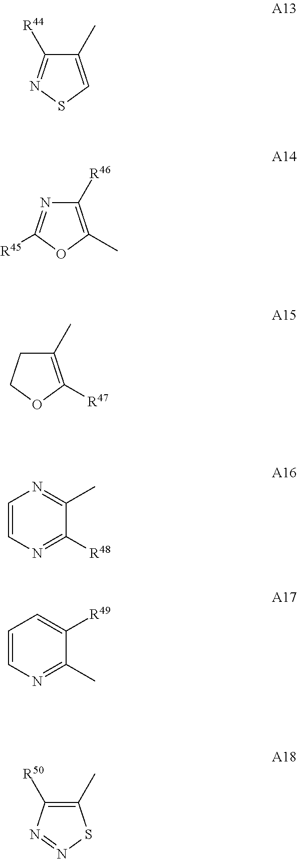
R¹⁸ represents hydrogen, cyano, halogen, nitro, C₁-C₄-alkyl, C₁-C₄-alkoxy, C₁-C₄-alkylthio, C₃-C₆-cycloalkyl, C₁-C₄-haloalkyl, C₁-C₄-haloalkoxy or C₁-C₄-haloalkylthio comprising in each case 1 to 5 halogen atoms, aminocarbonyl or aminocarbonyl-C₁-C₄-alkyl,
R¹⁹ represents hydrogen, halogen, cyano, C₁-C₄-alkyl, C₁-C₄-alkoxy or C₁-C₄-alkylthio,
R²⁰ represents hydrogen, C₁-C₄-alkyl, hydroxy-C₁-C₄-alkyl, C₂-C₆-alkenyl, C₃-C₆-cycloalkyl, C₁-C₄-alkylthio-C₁-C₄-alkyl, C₁-C₄-alkoxy-C₁-C₄-alkyl, C₁-C₄-haloalkyl, C₁-C₄-haloalkylthio-C₁-C₄-alkyl, C₁-C₄-haloalkoxy-C₁-C₄-alkyl comprising in each case 1 to 5 halogen atoms, or phenyl,
R²¹ and R²² independently of one another represent hydrogen, halogen, C₁-C₄-alkyl or C₁-C₄-haloalkyl comprising 1 to 5 halogen atoms,
R²³ represents halogen, cyano or C₁-C₄-alkyl, or C₁-C₄-haloalkyl or C₁-C₄-haloalkoxy comprising in each case 1 to 5 halogen atoms,
R²⁴ and R²⁵ independently of one another represent hydrogen, halogen, C₁-C₄-alkyl or C₁-C₄-haloalkyl comprising 1 to 5 halogen atoms,
R²⁶ represents hydrogen, halogen, C₁-C₄-alkyl or C₁-C₄-haloalkyl comprising 1 to 5 halogen atoms,
R²⁷ represents halogen, hydroxyl, cyano, C₁-C₆-alkyl, C₁-C₄-haloalkyl, C₁-C₄-haloalkoxy or C₁-C₄-haloalkylthio comprising in each case 1 to 5 halogen atoms,
R²⁸ represents halogen, hydroxyl, cyano, C₁-C₄-alkyl, C₁-C₄-alkoxy, C₁-C₄-alkylthio, C₁-C₄-haloalkyl, C₁-C₄-haloalkylthio or C₁-C₄-haloalkoxy comprising in each case 1 to 5 halogen atoms,
R²⁹ represents hydrogen, halogen, cyano, C₁-C₄-alkyl, C₁-C₄-alkoxy, C₁-C₄-alkylthio, C₁-C₄-haloalkyl, C₁-C₄-haloalkoxy comprising in each case 1 to 5 halogen atoms, C₁-C₄-alkylsulphinyl or C₁-C₄-alkylsulphonyl,
R³⁰ represents C₁-C₄-alkyl or C₁-C₄-haloalkyl comprising 1 to 5 halogen atoms,
R³¹ represents C₁-C₄-alkyl,
Q¹ represents S sulphur, SO, SO₂ or CH₂,
p represents 0, 1 or 2, wherein R³¹ represents identical or different radicals if p represents 2,
R³² represents C₁-C₄-alkyl or C₁-C₄-haloalkyl comprising 1 to 5 halogen atoms,
R³³ represents C₁-C₄-alkyl or C₁-C₄-haloalkyl comprising 1 to 5 halogen atoms,
R³⁴ and R³⁵ independently of one another represent hydrogen, halogen, amino, C₁-C₄-alkyl or C₁-C₄-haloalkyl comprising 1 to 5 halogen atoms,
R³⁶ represents hydrogen, halogen, C₁-C₄-alkyl or C₁-C₄-haloalkyl comprising 1 to 5 halogen atoms,
R³⁷ and R³⁸ independently of one another represent hydrogen, halogen, amino, nitro, C₁-C₄-alkyl or C₁-C₄-haloalkyl comprising 1 to 5 halogen atoms,
R³⁹ represents hydrogen, halogen, C₁-C₄-alkyl or C₁-C₄-haloalkyl comprising 1 to 5 halogen atoms,
R⁴⁰ represents hydrogen, halogen, amino, C₁-C₄-alkylamino, di-(C₁-C₄-alkyl)amino, cyano, C₁-C₄-alkyl or C₁-C₄-haloalkyl comprising 1 to 5 halogen atoms,
R⁴¹ represents halogen, C₁-C₄-alkyl or C₁-C₄-haloalkyl comprising 1 to 5 halogen atoms,
R⁴² represents hydrogen, halogen, amino, C₁-C₄-alkylamino, di-(C₁-C₄-alkyl)amino, cyano, C₁-C₄-alkyl or C₁-C₄-haloalkyl comprising 1 to 5 halogen atoms,
R⁴³ represents halogen, C₁-C₄-alkyl or C₁-C₄-haloalkyl comprising 1 to 5 halogen atoms,
R⁴⁴ represents halogen, C₁-C₄-alkyl or C₁-C₄-haloalkyl comprising 1 to 5 halogen atoms,
R⁴⁵ represents hydrogen or C₁-C₄-alkyl,
R⁴⁶ represents halogen or C₁-C₄-alkyl,
R⁴⁷ represents C₁-C₄-alkyl or C₁-C₄-haloalkyl comprising 1 to 5 halogen atoms,
R⁴⁸ represents hydrogen, halogen, C₁-C₄-alkyl or C₁-C₄-haloalkyl comprising 1 to 5 halogen atoms,
R⁴⁹ represents halogen, hydroxyl, C₁-C₄-alkyl, C₁-C₄-alkoxy, C₁-C₄-alkylthio, C₁-C₄-haloalkyl, C₁-C₄-haloalkylthio or C₁-C₄-haloalkoxy comprising in each case 1 to 5 halogen atoms,
R⁵⁰ represents C₁-C₄-alkyl.

5. A method for producing compound according to formula (Ia) or (Ib) according to the following reaction schemes. 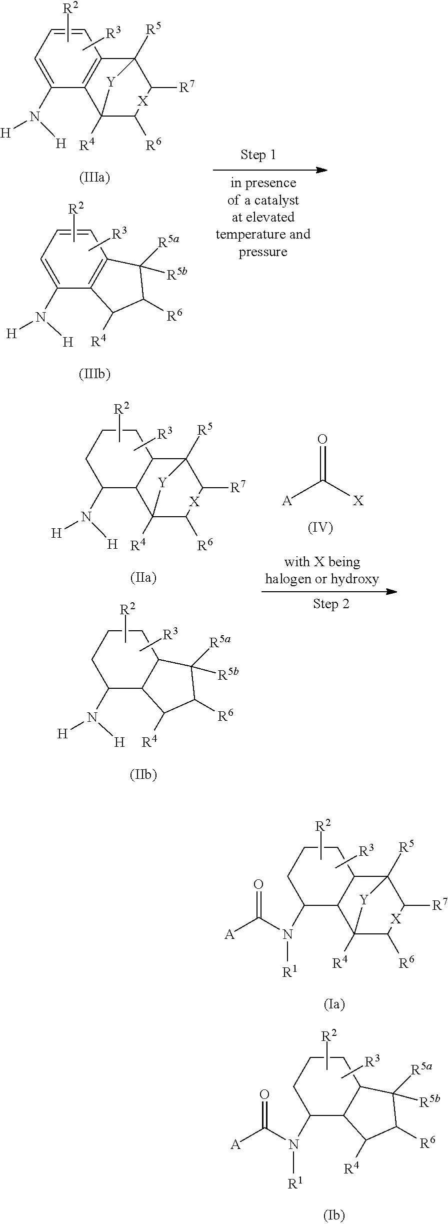
Wherein
X is a single or double bond;
Y is O, S, N(R¹¹) or (CR¹²R¹³)(CR¹⁴R¹⁵)ₘ(CR¹⁶R¹⁷)ₙ;
m is 0 or 1;
n is 0 or 1;
R¹ is hydrogen, C₁₋₄ alkyl, C₁₋₄ haloalkyl, C₁₋₄ alkoxy, C₁₋₄ haloalkoxy, CH₂C≡CR⁸, CH₂CR^{9a}═CHR^{9b}, CH═C═CH₂ or COR¹⁰;
R² and R³ are each, independently, hydrogen, halogen, C₁₋₄ alkyl, C₁₋₄ alkoxy or C₁₋₄ haloalkoxy;
R⁴, R⁵, R⁶, R⁷, R^{5a} and R^{5b} are each, independently, hydrogen, halogen, C₁₋₄ alkyl, C₁₋₄ haloalkyl, C₁₋₄ alkoxy, C₁₋₄ haloalkoxy, C₁₋₄ alkylthio, C₁₋₄ haloalkylthio, hydroxymethyl, C₁₋₄ alkoxymethyl, C(O)CH₃ or C(O)OCH₃;
R⁸, R^{9a} and R^{9b} are each, independently, hydrogen, halogen, C₁₋₄ alkyl, C₁₋₄ haloalkyl or C₁₋₄ alkoxy(C₁₋₄)alkylene;
and R¹⁰ is hydrogen, C₁₋₆ alkyl, C₁₋₆ haloalkyl, C₁₋₄alkoxy(C₁₋₄) alkylene, C₁₋₄ alkyl-S— (C₁₋₄) alkylene, C₁₋₄ alkoxy or aryl;
R¹¹ is hydrogen, C₁₋₄ alkyl, benzyl wherein the phenyl group is optionally substituted with up to three substituents, each independently selected from halogen, C₁₋₄ alkyl, C₁₋₄ haloalkyl and C₁₋₄ alkoxy, formyl, C(O)C₁₋₄ alkyl optionally substituted by halogen or C₁₋₄ alkoxy, C(═O)O—C₁₋₆ alkyl optionally substituted by halogen, C₁₋₄ alkoxy or cyano or C₁₋₄ alkoxy(C₁₋₄)alkylene;
R¹², R¹³, R¹⁴, R¹⁵, R¹⁶ and R¹⁷ are each, independently, hydrogen, halogen, hydroxy, C₁₋₆ alkyl, C₂₋₆ alkenyl both optionally substituted by halogen, hydroxy, C₁₋₄ alkoxy, ═O, aryl or O—C(O)—C₁₋₄ alkyl or a 3-7 membered carboxylic ring itself optionally substituted by up to three methyl groups, a 3-7 membered saturated ring optionally substituted by up to three methyl groups and optionally containing one heteroatom selected from nitrogen and oxygen or C₁₋₄ alkoxy;
or R¹² and R¹³ together with the carbon atom to which they are attached form the group C═O or a 3-5 membered carbocyclic ring optionally substituted by up to three methyl groups and optionally with up to 2 heteroatoms each independently selected from O and N;
or R¹² and R¹³ together form a C₁₋₆ alkylidene optionally substituted by up to three methyl groups or a C₃₋₆ cycloalkylidene group optionally substituted by up to three methyl groups;
A represents one of the radicals A1 to A18 below 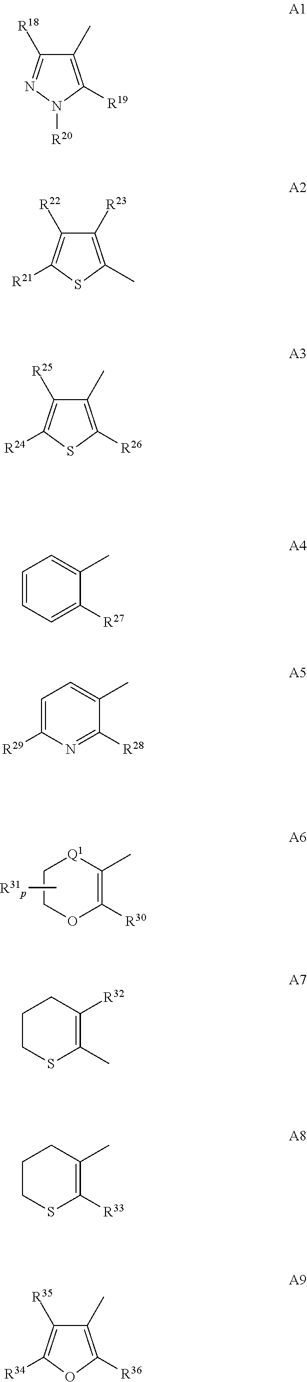 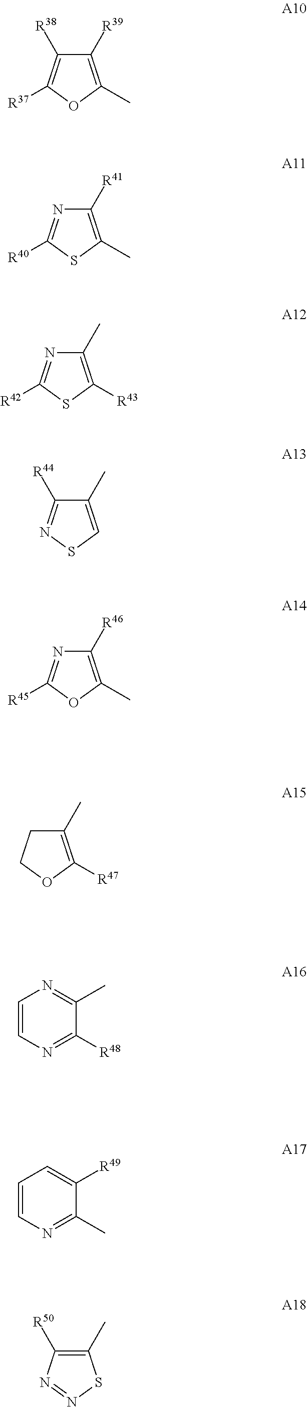
R¹⁸ represents hydrogen, cyano, halogen, nitro, C₁-C₄-alkyl, C₁-C₄-alkoxy, C₁-C₄-alkylthio, C₃-C₆-cycloalkyl, C₁-C₄-haloalkyl, C₁-C₄-haloalkoxy or C₁-C₄-haloalkylthio comprising in each case 1 to 5 halogen atoms, aminocarbonyl or aminocarbonyl-C₁-C₄-alkyl,
R¹⁹ represents hydrogen, halogen, cyano, C₁-C₄-alkyl, C₁-C₄-alkoxy or C₁-C₄-alkylthio,
R²⁰ represents hydrogen, C₁-C₄-alkyl, hydroxy-C₁-C₄-alkyl, C₂-C₆-alkenyl, C₃-C₆-cycloalkyl, C₁-C₄-alkylthio-C₁-C₄-alkyl, C₁-C₄-alkoxy-C₁-C₄-alkyl, C₁-C₄-haloalkyl, C₁-C₄-haloalkylthio-C₁-C₄-alkyl, C₁-C₄-haloalkoxy-C₁-C₄-alkyl comprising in each case 1 to 5 halogen atoms, or phenyl,
R²¹ and R²² independently of one another represent hydrogen, halogen, C₁-C₄-alkyl or C₁-C₄-haloalkyl comprising 1 to 5 halogen atoms,
R²³ represents halogen, cyano or C₁-C₄-alkyl, or C₁-C₄-haloalkyl or C₁-C₄-haloalkoxy comprising in each case 1 to 5 halogen atoms,
R²⁴ and R²⁵ independently of one another represent hydrogen, halogen, C₁-C₄-alkyl or C₁-C₄-haloalkyl comprising 1 to 5 halogen atoms,
R²⁶ represents hydrogen, halogen, C₁-C₄-alkyl or C₁-C₄-haloalkyl comprising 1 to 5 halogen atoms,
R²⁷ represents halogen, hydroxyl, cyano, C₁-C₆-alkyl, C₁-C₄-haloalkyl, C₁-C₄-haloalkoxy or C₁-C₄-haloalkylthio comprising in each case 1 to 5 halogen atoms,
R²⁸ represents halogen, hydroxyl, cyano, C₁-C₄-alkyl, C₁-C₄-alkoxy, C₁-C₄-alkylthio, C₁-C₄-haloalkyl, C₁-C₄-haloalkylthio or C₁-C₄-haloalkoxy comprising in each case 1 to 5 halogen atoms,
R²⁹ represents hydrogen, halogen, cyano, C₁-C₄-alkyl, C₁-C₄-alkoxy, C₁-C₄-alkylthio, C₁-C₄-haloalkyl, C₁-C₄-haloalkoxy comprising in each case 1 to 5 halogen atoms, C₁-C₄-alkylsulphinyl or C₁-C₄-alkylsulphonyl,
R³⁰ represents C₁-C₄-alkyl or C₁-C₄-haloalkyl comprising 1 to 5 halogen atoms,
R³¹ represents C₁-C₄-alkyl,
Q¹ represents S sulphur, SO, SO₂ or CH₂,
p represents 0, 1 or 2, wherein R³¹ represents identical or different radicals if p represents 2,
R³² represents C₁-C₄-alkyl or C₁-C₄-haloalkyl comprising 1 to 5 halogen atoms,
R³³ represents C₁-C₄-alkyl or C₁-C₄-haloalkyl comprising 1 to 5 halogen atoms,
R³⁴ and R³⁵ independently of one another represent hydrogen, halogen, amino, C₁-C₄-alkyl or C₁-C₄-haloalkyl comprising 1 to 5 halogen atoms,
R³⁶ represents hydrogen, halogen, C₁-C₄-alkyl or C₁-C₄-haloalkyl comprising 1 to 5 halogen atoms,
R³⁷ and R³⁸ independently of one another represent hydrogen, halogen, amino, nitro, C₁-C₄-alkyl or C₁-C₄-haloalkyl comprising 1 to 5 halogen atoms,
R³⁹ represents hydrogen, halogen, C₁-C₄-alkyl or C₁-C₄-haloalkyl comprising 1 to 5 halogen atoms,
R⁴⁰ represents hydrogen, halogen, amino, C₁-C₄-alkylamino, di-(C₁-C₄-alkyl)amino, cyano, C₁-C₄-alkyl or C₁-C₄-haloalkyl comprising 1 to 5 halogen atoms,
R⁴¹ represents halogen, C₁-C₄-alkyl or C₁-C₄-haloalkyl comprising 1 to 5 halogen atoms,
R⁴² represents hydrogen, halogen, amino, C₁-C₄-alkylamino, di-(C₁-C₄-alkyl)amino, cyano, C₁-C₄-alkyl or C₁-C₄-haloalkyl comprising 1 to 5 halogen atoms,
R⁴³ represents halogen, C₁-C₄-alkyl or C₁-C₄-haloalkyl comprising 1 to 5 halogen atoms,
R⁴⁴ represents halogen, C₁-C₄-alkyl or C₁-C₄-haloalkyl comprising 1 to 5 halogen atoms,
R⁴⁵ represents hydrogen or C₁-C₄-alkyl,
R⁴⁶ represents halogen or C₁-C₄-alkyl,
R⁴⁷ represents C₁-C₄-alkyl or C₁-C₄-haloalkyl comprising 1 to 5 halogen atoms,
R⁴⁸ represents hydrogen, halogen, C₁-C₄-alkyl or C₁-C₄-haloalkyl comprising 1 to 5 halogen atoms,
R⁴⁹ represents halogen, hydroxyl, C₁-C₄-alkyl, C₁-C₄-alkoxy, C₁-C₄-alkylthio, C₁-C₄-haloalkyl, C₁-C₄-haloalkylthio or C₁-C₄-haloalkoxy comprising in each case 1 to 5 halogen atoms,
R⁵⁰ represents C₁-C₄-alkyl.

6. A composition for controlling microorganisms and/or preventing attack and/or infestation of a plant therewith, comprising an active ingredient comprising a compound of formula (Ia) or (Ib) as claimed in claim 1 together with a suitable carrier.

7. A method of controlling and/or preventing infestation of cultivated plants by phytopathogenic microorganism comprising applying a compound of formula (Ia) or (Ib) as claimed in claim 1 to a plant, to a part thereof and/or a locus thereof.
